(19) United States
(12) Patent Application Publication
(10) Pub. No.: US 2024/0356712 A1
(43) Pub. Date: Oct. 24, 2024

(54) APPARATUS AND METHOD FOR CONTROL OF HARQ-ACK CODEBOOK SELECTION FOR WIRELESS COMMUNICATION

(71) Applicant: Telefonaktiebolaget LM (publ), Stockholm (SE)

(72) Inventors: Ping Yu, Ottawa (CA); Ramy Atawia, Kanata (CA); Geoffrey McHardy, Carp (CA)

(21) Appl. No.: 18/260,794

(22) PCT Filed: Jan. 11, 2022
(86) PCT No.: PCT/IB2022/050192

§ 371 Date: Jul. 10, 2023

Related U.S. Application Data
(60) Provisional application No. 63/137,892, filed on Jan. 15, 2021.

(51) Int. Cl. H04L 5/00; H04L 1/00

(52) U.S. Cl. CPC H04L 5/0055; H04L 1/001; H04L 1/0046

(57) ABSTRACT

Disclosed techniques provide for selection of the codebook type used by a User Equipment (UE) (12), for Hybrid Automatic Repeat reQuest (HARQ) feedback to a wireless communication network (10) in multi-connectivity scenarios. The particular HARQ-ACK codebook type selected for use by the UE (12) depends on a delay associated with transferring HARQ feedback received from the UE (12) for a secondary cell (34) to the processing entity (42) that is responsible for downlink transmission control in the secondary cell (34). For example, the HARQ feedback is received via a first or primary cell (34) and then transferred from there to a radio network node or other geographically-remote circuitry that performs the downlink transmission control for the secondary cell (34).

### TECHNICAL FIELD

Disclosed techniques provide for selection of the codebook type used by a wireless communication device, for Hybrid Automatic Repeat reQuest (HARQ) feedback to a wireless communication network in multi-connectivity scenarios.

### BACKGROUND

Wireless communication networks use various approaches for ensuring accurate transmission of data and providing for retransmission when needed. The term “HARQ” refers to one such mechanism, where “HARQ” denotes Hybrid Automatic Repeat reQuest. At the physical layer—i.e., the layer involving transmission and reception via the physical medium-HARQ provides for fast retransmission control, e.g., with a receiving node returning acknowledgements (ACKs) or non-acknowledgements (NACKs) for respective transmissions of data from a transmitting node. Such signaling may be referred to as HARQ-ACK feedback or, more simply, HARQ feedback.

One mechanism finding increasing use in certain kinds of wireless communication networks is “carrier aggregation” or “CA,” with Fifth Generation (5G) New Radio (NR) networks operating according to Third Generation Partnership Project (3GPP) specifications being one example involving CA. With carrier aggregation, two or more carriers are aggregated by the network for use in serving a User Equipment (UE), with the individual carriers in a CA configuration being referred to as “component carriers” or “CCs.”

A “carrier” may be understood as a set or sets of radio resources, e.g., a range of frequencies having a bandwidth and a center frequency, having a defined radio signal structure that provides time/frequency resources for use in transmitting or receiving. Carriers used for transmitting from the network to a UE are referred to as downlink (DL) carriers, while carriers used for transmitting from UEs to the network are referred to as uplink (UL) carriers. A given CA configuration may or may not equal numbers of DL carriers and UL carriers, and the term “cell” may be used interchangeably with “carrier,” with the understanding that, unless otherwise noted, the term “cell” may refer to both a DL carrier and an UL carrier, or either one. While a given “cell” may be associated with particular geographic area of service coverage provided by the network, coverage areas may be dynamic, e.g., in the case of beamforming.

In operation in the CA context, then, the UE may receive downlink data transmissions in more than one cell, meaning that HARQ feedback from the UE may include feedback for transmissions in different cells. However, in 3GPP contexts, one of the cells involved in a CA group of cells may be used for receiving HARQ feedback from the UE, for all of the cells in CA group of cells. For example, a “special cell” or SpCell in the CA group receives HARQ feedback from the UE for other cells in the CA group. More generally, in any given arrangement where one cell receives own-cell and other-cell HARQ feedback from the UE, the other-cell feedback must be provided to the entity/entities that are responsible for managing transmissions in the other cells.

In scenarios where the other cell(s) are not controlled by the same network node that controls the cell in which the feedback was received, the HARQ feedback for the other cell(s) must be transferred to the responsible entities within the network, e.g., using backhaul or sidehaul connections. For example, in a 5G NR context, where network operators may use carriers (cells) at substantially different frequencies, CA configurations may involve geographically-separated radio access nodes, meaning that the control entity/entities that manage transmissions in the respective cells generally will not be co-located. In other scenarios, involving processing clouds or data-center virtualizations, there may be a need to transfer HARQ feedback from UEs within the network, for processing and use by the appropriate entities.

As noted, in the NR context, very large ranges of carrier frequencies can be supported. NR Inter-gNB carrier aggregation (CA) allows NR users to utilize simultaneously multiple bands from non-co-located gNBs as shown in FIG. 1. Particularly, FIG. 1 illustrates a CA arrangement, where the network serves a UE using two cells—one cell operating in frequency band “Y” and the other cell operating in frequency band “X.” Both cells provide for downlink data transmissions to the UE, with the UE returning HARQ feedback for both cells on the uplink connection to the cell operating in frequency band X—e.g., the band-X cell is, in the context of the CA configuration, a Primary Cell (PCell), and the band-Y cell is a Secondary Cell (SCell) in the CA configuration.

CA arrangements increase the end user throughput and provide load balancing between spectrum bands without need to deploy more hardware. A further benefit of the arrangement is increasing the coverage of gNBs operating in high frequency ranges.

### SUMMARY

Disclosed techniques provide for selection of the codebook type used by a User Equipment (UE), for Hybrid Automatic Repeat reQuest (HARQ) feedback to a wireless communication network in multi-connectivity scenarios. The particular HARQ-ACK codebook type selected for use by the UE depends on a delay associated with transferring HARQ feedback received from the UE for a secondary cell to the processing entity that is responsible for downlink transmission control in the secondary cell. For example, the HARQ feedback is received via a first or primary cell and then transferred from there to a radio network node or other geographically-remote circuitry that performs the downlink transmission control for the second cell.

As one example, in a 5G NR context, where network operators may use carriers at substantially different frequencies, CA configurations may involve geographically-separated radio access nodes, meaning that the control entity/entities that manage transmissions in the respective cells generally will not be co-located. In other scenarios, involving processing clouds or data-center virtualizations, there may be a need to transfer HARQ feedback from UEs within the network, for processing and use by the appropriate entities.

An example embodiment comprises a method performed by a network node included in or communicatively coupled to a wireless communication network. The method includes evaluating a delay associated with transferring Hybrid Automatic Repeat reQuest ACK (HARQ-ACK) feedback received from a User Equipment (UE) for a second cell of the wireless communication network, over a backhaul or sidehaul link of the wireless communication network to a processing entity that is responsible for downlink transmission control in the second cell. The wireless communication network receives the HARQ-ACK feedback in a first cell of the wireless communication network that belongs to a Carrier Aggregation (CA) that is associated with the UE and further includes the second cell. The method further includes selecting, based on the delay evaluation, a particular HARQ-ACK codebook type from among two or more defined HARQ-ACK codebook types, for use by the UE in configuring the HARQ-ACK feedback.

Another example embodiment comprises a network node configured for operation in wireless communication network. The network node includes communication circuitry and processing circuitry that is operatively associated with the communication circuitry. The communication circuitry is configured for exchanging signaling with at least one of: other network nodes of the wireless communication network or User Equipments (UEs) served by the wireless communication network. The processing circuitry is configured to evaluate a delay associated with transferring HARQ-ACK feedback received from a UE for a second cell of the wireless communication network, over a backhaul or sidehaul link of the wireless communication network to a processing entity that is responsible for downlink transmission control in the second cell. The wireless communication network receives the HARQ-ACK feedback in a first cell of the wireless communication network that belongs to a CA that is associated with the UE and further includes the second cell. Further, the processing circuitry of the network node is configured to select, based on the delay evaluation, a particular HARQ-ACK codebook type from among two or more defined HARQ-ACK codebook types, for use by the UE in configuring the HARQ-ACK feedback.

Of course, the present invention is not limited to the above features and advantages. Indeed, those skilled in the art will recognize additional features and advantages upon reading the following detailed description, and upon viewing the accompanying drawings.

### BRIEF DESCRIPTION OF THE DRAWINGS

FIG. 1 is a block diagram illustrating an example arrangement of radio access nodes of a wireless communication network, providing communication service(s) to a User Equipment (UE) in a carrier aggregation configuration with frequency bands X and Y transmitted from different radio access nodes.

FIG. 2 depicts example plots of “K1” configuration and total HARQ delays for dynamic and semi-static HARQ codebook types, for different inter-gNB delays.

FIG. 3 is an example plot providing performance comparisons between dynamic and semi-static HARQ codebook types, for different inter-gNB delays and different numbers of UEs.

FIG. 4 is a block diagram of one embodiment of a wireless communication network.

FIG. 5 is a block diagram of example details for the network of FIG. 1.

FIG. 6 is a block diagram of one embodiment of a network node configured to perform or support HARQ codebook type selection.

FIG. 7 is a block diagram of example implementation details for a network node that performs or supports HARQ codebook type selection.

FIGS. 8-10 are logic flow diagrams of example embodiments of one or more methods of operation, for supporting or performing HARQ codebook type selection.

FIG. 11 is a block diagram illustrating another example embodiment of a network node that is configured to perform or support HARQ codebook type selection.

FIG. 12 is a logic flow diagram of a further example embodiment of a method of operation, for supporting or performing HARQ codebook type selection.

FIG. 13 is a logic flow diagram of a further example embodiment of a method of operation, for supporting or performing HARQ codebook type selection.

FIG. 14 is a logic flow diagram of a further example embodiment of a method of operation, for supporting or performing HARQ codebook type selection.

FIG. 15 is a signal flow diagram of one embodiment of signaling between respective network entities, for supporting or performing HARQ codebook type selection.

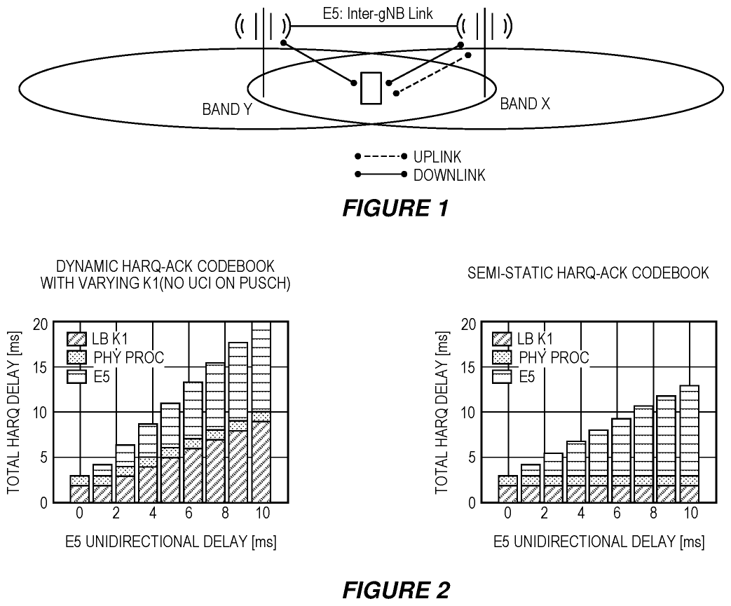

FIG. YY2 is a block diagram of another embodiment of a network node, e.g., a radio network node or other node of a wireless communication network.

FIG. QQ1 is a block diagram of a wireless communication network according to some embodiments.

FIG. QQ2 is a block diagram of a user equipment according to some embodiments.

FIG. QQ3 is a block diagram of a virtualization environment according to some embodiments.

FIG. QQ4 is a block diagram of a communication network with a host computer according to some embodiments.

FIG. QQ5 is a block diagram of a host computer according to some embodiments.

FIG. QQ6 is a flowchart illustrating a method implemented in a communication system, in accordance with one embodiment.

FIG. QQ7 is a flowchart illustrating a method implemented in a communication system, in accordance with one embodiment.

FIG. QQ8 is a flowchart illustrating a method implemented in a communication system, in accordance with one embodiment.

FIG. QQ9 is a flowchart illustrating a method implemented in a communication system, in accordance with one embodiment.

FIGS. VV1 and VV2 are block diagrams illustrating example embodiments of a virtualized wireless communication device and a virtualized network node.

### DETAILED DESCRIPTION

Within the 3GPP context, there are different types of HARQ-ACK codebooks supported, with current specifications defining a semi-static codebook type and dynamic codebook type. As an example understanding, the semi-static “type” of codebook uses a fixed arrangement and size for the HARQ feedback, which may be simpler to manage and process, as between the network and the involved UE, but can be less efficient than the “dynamic” type of codebook, which varies in size in dependence on the number of downlink transmissions being reported.

Additional codebook types may be introduced, or variations of the existing dynamic and semi-static codebooks may be developed, and the apparatus and methods disclosed herein provide for evaluation and selection between semi-static and dynamic codebook types and have applicability to the selection between further or other codebook types, as may be introduced in the future or used in other communication standards.

A mechanism disclosed herein provides, according to one or more embodiments, for initial selection and dynamic reselection of the HARQ-ACK codebook type used by a given UE. Particular advantages, e.g., in performance improvements or efficiencies, may be gained in scenarios where two or more of the cells involved in the HARQ feedback from the UE are not co-located or, more broadly, in cases where a given cell in a CA used for a UE receives own-cell HARQ and other-cell HARQ and at least the other-cell HARQ has to be transferred across or between nodes in the network, for use by the entity that uses/responds to the other-cell HARQ.

Consider a scenario involving two cells, each cell managed by a respective radio access node, e.g., by a respective gNB. Where one gNB receives HARQ feedback for a cell controlled by another gNB, delays arise in association with transferring the HARQ feedback to the other gNB, for use by the other gNB in managing transmissions/retransmissions for its cell. The delays depend on many factors, such as the distance between gNBs and the quality of the backhaul or sidehaul connection between them (e.g., routers and hubs on the network links between them).

As recognized herein, numerous considerations arise regarding HARQ-ACK codebook type selection in CA scenarios involving non-co-located gNBs/cells, especially when the non-co-located cells use different NR numerologies. Problems arising from inter-gNB link delays often result in any one or more of the following problems, which heretofore have not been addressed or accounted for in HARQ-ACK codebook type selection:
1. Delayed feedback from UE (which impacts end-to-end (E2E) latency).
2. HARQ process exhaustion which requires special handling such as deploying HARQ process reuse.
3. Different requirements on the HARQ feedback offset (i.e., the “K1” in 3GPP specifications) for each codebook type as demonstrated by the plots depicted in FIG. 2, where the delay of the inter-gNB link for communicating the HARQ feedback from SpCell to SCells.
4. Consideration on carrier deployment when more than 2 nodes are involved with coordination of carriers.
5. 3GPP requirements to align on DAI values for when the UE transmits HARQ-ACK feedback for SpCell and SCell at the same slot.
6. The ability to decode the selected HARQ-ACK codebook at different UL radio conditions.

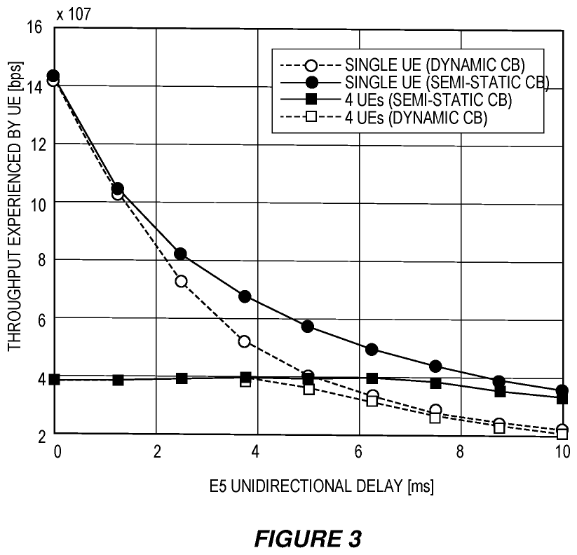

FIG. 3 illustrates the performance of both HARQ-ACK codebook types (semi-static and dynamic) simulated at different inter-gNB delay (x-axis) and number of users (active UEs). When the number of users is relatively low, e.g., below some threshold, the UE-experienced throughput is maintained with use of the semi-static codebook type, even for relatively high inter-node delay values, as compared to use of the dynamic codebook type. However, this advantage vanishes at very small inter-node delays or with larger numbers of users. Therefore, other factors, such as air-interface transmission overhead (due to codebook size) will make the dynamic HARQ-ACK codebook more favorable under some circumstances.

In one or more embodiments described herein, one or more metrics are used to assist the network-side selection of the HARQ-ACK codebook type to be used by a UE. Here, “selection” refers to initial selection or a subsequent or repeated dynamic reselection. In at least one embodiment, two or more metrics are considered in combination, e.g., a joint or weighted evaluation, meaning that multiple aspects of prevailing considerations or conditions are considered for deciding which type of HARQ-ACK codebook to select for use by a UE. Hereafter, for convenience, any reference to “codebook” or “codebook type” shall be understood to mean HARQ-ACK codebooks or codebook types, unless otherwise noted.

In an example approach, the metrics are organized such that a weight can be scaled independently for each metric, depending on the desired trade-offs between UE capability and performance versus spectrum usage and efficiency.

The metrics used are a combination of measured observation such as air interface load as well as calculated theoretical capability given a selected configuration. As an example, if the calculation for HARQ process exhaustion determines that there are sufficient resources using dynamic HARQ codebook then it is likely that dynamic codebook will be selected due to its lower cost associated with other metrics such as UL coverage.

This selection decision in one or more embodiments is performed “blindly” with respect to a UE first connecting to the network and may also be evaluated over the connection lifetime of the UE, as dynamic aspects of the described metrics change, or the UE configuration is adjusted for other purposes.

Example implementation details are best understood in conjunction with discussing example arrangements in a wireless communication network that supports carrier aggregation (CA), where the network uses more than one carrier for serving a UE—e.g., a CA arrangement where the network serves the UE using a PCell and a SCell. In this context, an entity in the network controls the selection of the HARQ codebook type used by the UE, in dependence on evaluating one or more metrics, such as a metric that accounts for inter-node delays that arise as a consequence of a node in the network receiving HARQ feedback from the UE, where the feedback is for a cell that is controlled by another, non-co-located node of the network. Of course, there may be more than two cells involved.

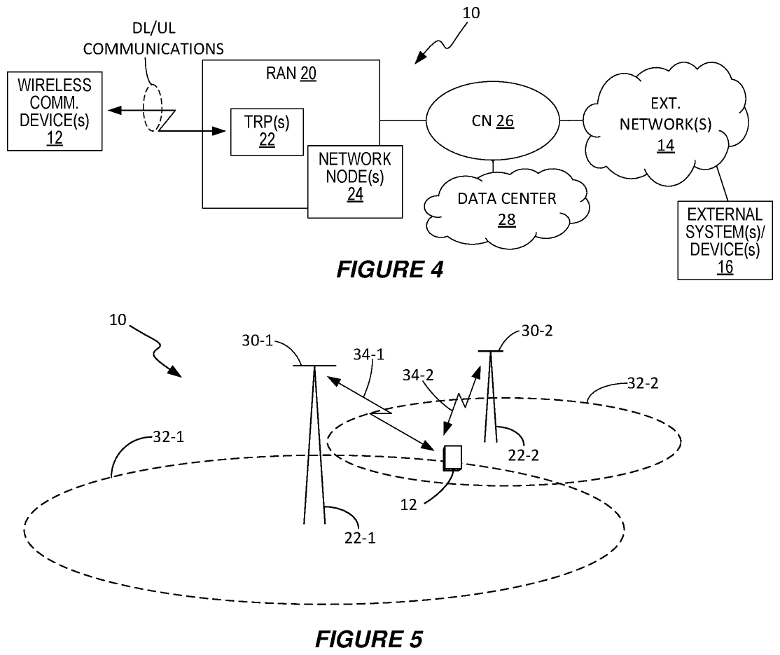

FIG. 4 illustrates an example wireless communication network 10. By way of example, the network 10 is a Fifth Generation (5G) New Radio (NR) network or other Third Generation Partnership Project (3GPP) wireless communication network. For ease of illustration and discussion, only a limited number of entities (nodes, etc.) appear in the diagram, and it shall be understood that the network 10 may have additional instances of the entities that are illustrated and may include other entities that are not illustrated.

In the example depiction, the network 10 provides one or more types of communication services to wireless communication devices, also referred to as “wireless devices,” “User Equipments,” or “UEs.” One wireless communication device 12 is shown for example purposes, and it may be a smartphone or other personal communication device, a laptop or other computer, a wireless network adaptor or other “embedded” UE, such as used for Machine Type Communication (MTC) applications in a Machine-to-Machine (M2M) context.

The wireless communication device 12 uses the network 10 as an “access” network for communicating with other devices or systems, such as coupling through the network 10 to the Internet or another external network 14, which provides access to one or more external systems or devices 16, such as application servers that provide one or more types of communication services.

A Radio Access Network (RAN) 20 of the network 10 includes one or more radio network nodes 22 that operate as or control one or more respective Transmission/Reception Points (TRPs) 22. In one example, the TRP(s) 22 are gNBs or other type of base stations and they may use beamforming. Broadly, the TRP(s) 22 may be essentially any type of consolidated or distributed radio transmission/reception equipment that provides radio access for wireless communication devices 12, and other labels such as “access point,” “radio network node,” etc., may be used for them.

FIG. 4 also depicts one or more network nodes 24, that support or perform HARQ codebook selection as contemplated herein. There may be multiple such nodes 24, e.g., where each of multiple TRPs 22 incorporate the contemplated codebook-selection functionality. In other instances, a single network node 24 may provide the code-book selection functionality for multiple TRPs 22, as needed, e.g., multiple network nodes 24 each support a corresponding set or group of TRPs 22, such as groups of neighboring TRPs 22 that are usable together for CA with respect to one or more coverage areas of the network 10. Although the network node(s) 24 are shown in the RAN 20, they may be implemented in the Core Network (CN) 26 portion of the network 10, or in a data center 28 that provides processing services to the network 10 for one or more network operations.

Each TRP 22 provides one or more cells, and the coverage area associated with a given cell may overlap with the coverage area associated with one or more other given cells, meaning that a wireless communication device 12 (hereafter, UE 12) in the overlapped coverage area may be served by more than one cell. Although a given TRP 22 may provide more than one cell, e.g., a TRP 22 provides one cell in a first frequency band and another cell in another frequency band, there are certain aspects of codebook selection contemplated herein that apply to the particular case where two or more of the cells used to serve a UE 12 are not controlled by the same TRP 22.

FIG. 5 illustrates an example scenario, depicting two TRPs 22-1 and 22-2 for the network 10. The TRP 22-1 includes or interfaces with an antenna system 30-1 and is generally associated with a coverage area 32-1. Likewise, the TRP 22-2 includes or interfaces with an antenna system 30-2 and is generally associated with a coverage area 32-2. A UE 12 located in an overlap of the two coverage areas 32 may enjoy sufficiently good signal quality with respect to a first carrier (cell) 34-1 provided by the TRP 22-1 and a second carrier (cell) 34-2 provided by the TRP 22-2, meaning that the network 10 may use a CA configuration for serving the UE 12 from both cells 34-1 and 34-2.

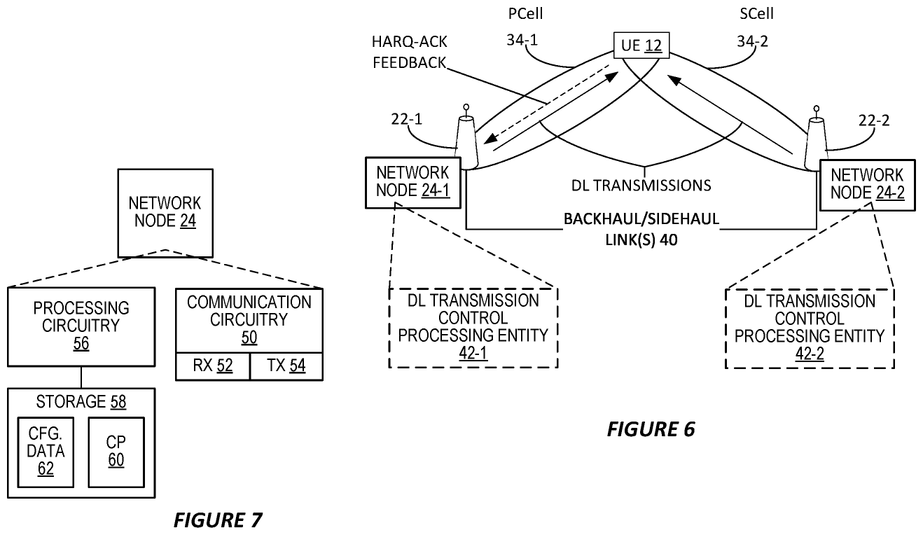

FIG. 6 illustrates a CA scenario, where the network 10 serves a UE 12 using a first cell 34-1 (as the primary or PCell) and a second cell 34-2 (as the secondary or SCell). With respect to the UE 12 receiving scheduled transmissions of downlink data in both cells 34, the UE 12 transmits its HARQ feedback in the first cell 34-1, where that feedback includes ACK/NACK information, as needed, for both cells 34. The HARQ feedback pertaining to downlink transmission control in the second cell 34-2 is transferred from the TRP 22-1 to the TRP 22-2, using a communication link 40, which may be a backhaul link or a sidehaul link within the network, where “sidehaul” refers to connections between peer nodes.

Transferring the second-cell HARQ feedback from the TRP 22-1 to the TRP 22-2 involves delay—e.g., a network transport delay associated with the data-connection path used to convey the information. Such delays may vary, e.g., as a function of the communication “load” on the involved routing/switching equipment within the network (not shown in the diagram).

In the example of FIG. 6, each cell 34 is provided/controlled by a respective TRP 22, with each TRP 22 implementing the functionality described for a network node 24, and where each TRP 22 implements a downlink (DL) transmission control processing entity 42—e.g., via its included processing circuitry 56—to control DL transmissions in its respective cell 34. In this example, then, HARQ feedback for the second cell 34-2 is received via the first cell 34-1 and the transfer delay is the delay associated with transferring the HARQ feedback for the second cell 34-2 from the TRP 22-1 to the TRP 22-2.

FIG. 7 illustrates an example embodiment of a network node 24 that is operative to select the HARQ codebook type used by a given UE 12, in dependence on evaluating one or more metrics, such as network transport delays bearing on the transfer of HARQ feedback between nodes within the network 10 or uplink coverage conditions in the cell 34 used by the UE 12 for providing HARQ feedback for aggregated carriers. As a non-limiting example, the network node 24 is a gNB in a 5G NR embodiment of the network 10. Particularly, the gNB may be the gNB that controls the cell 34 used by the UE 12 for returning the HARQ feedback to the network 10.

The example network node 24 includes communication circuitry 50, which includes receiver (RX) circuitry 52 and transmitter (TX) circuitry 54. The communication circuitry 50 may comprise one or more types of communication circuits, such as radiofrequency circuitry for providing one or more cells 34, for communicating with UEs 12, along with one or more network interfaces, such as Ethernet or other data-network interfaces, for communicating with one or more other nodes of the same type or of different types in the network 10. In implementations where the network node 24 is not a TRP 22—i.e., not implemented as a radio network node of the RAN 20—it generally will not include radiofrequency circuitry but will include one or more types of inter-node communication interface circuitry.

Processing circuitry 56 of the network node 24 is operatively associated with the communication circuitry 50, meaning, for example, the processing circuitry 56 sends and receives control signaling or data via the communication circuitry 50. The processing circuitry 56 comprises, for example, one or more microprocessors, digital signal processors, FPGAs, ASICs, or other forms of digital processing circuitry. In at least one embodiment, the functional configuration of the processing circuitry 56 is realized via the execution of computer program instructions. For example, the processing circuitry 56 incorporates or is associated with storage 58, which stores one or more computer programs 60 comprising such program instructions. The storage 58 also may store configuration data 62, associated with operation of the network node 24 as described herein.

The storage 58 comprises one or more types of computer-readable media providing volatile or nonvolatile storage of the computer program(s) 60 and/or configuration data 62. As an example, the storage 58 comprises any one or any mix of SRAM, DRAM, NV RAM, FLASH memory, EEPROM, solid-state disk, or other memory device or circuit.

In an example embodiment, the network node 24 is included in or communicatively coupled to a wireless communication network 10, and the processing circuitry 56 of the network node 24 is configured to:
evaluate a delay associated with transferring Hybrid Automatic Repeat reQuest ACK (HARQ-ACK) feedback received from a User Equipment (UE) for a second cell of the wireless communication network, over a backhaul or sidehaul link of the wireless communication network to a processing entity that is responsible for downlink transmission control in the second cell, wherein the wireless communication network receives the HARQ-ACK feedback in a first cell of the wireless communication network that belongs to a Carrier Aggregation (CA) that is associated with the UE and further includes the second cell; and
select, based on the delay evaluation, a particular HARQ-ACK codebook type from among two or more defined HARQ-ACK codebook types, for use by the UE in configuring the HARQ-ACK feedback.

In an example embodiment, the first cell is a Primary Cell (PCell) in the CA and the second cell comprises one or more Secondary Cells (SCells) in the CA. Correspondingly, the processing circuitry 56 is configured to evaluate respective delays associated with the one or more SCells. Particularly, in one or more example embodiments and for a given CA configuration, one cell may be used to receive HARQ-ACK feedback for another cell, and the HARQ-ACK codebook type may be selected based on the delay associated with routing or providing the HARQ-ACK feedback to the entity that controls downlink transmissions in that other cell. The cell used to receive the HARQ-ACK feedback for the other cell, or for multiple other cells, in the CA arrangement may be referred to as a Special Cell or SpCell.

The processing circuitry 56 of the network node that carries the above method in one or more embodiments is further configured to transmit, or initiate the transmission of, signaling indicating the codebook selection to the UE 12. In implementations where the network node 24 is a radio network node, e.g., a TRP 22, it may transmit signaling indicating the codebook-selection decision to a UE 12 via radio signaling. In implementations where the network node 24 is not a radio network node, it may transmit signaling to another node in the network 10, either for forwarding to the UE 12 or to initiate the transmission of radio signaling to the UE 12, for indication to the UE 12 of the selection decision.

In one or more embodiments, each of the first and second cells is a component carrier having a defined bandwidth and center frequency and providing respective radio resources managed by the wireless communication network. In a particular example, and with respect to 3GPP terminology used in applicable 3GPP specifications, the first cell is a Special Cell (SpCell) in the CA and the second cell is a Secondary Cell (SCell) in the CA.

The evaluating and selecting operations are performed by the processing circuitry 56 for initial selection of the particular HARQ-ACK codebook type to be used by a UE 12, in association with connecting a given UE 12 with the wireless communication network 10. Additionally, or alternatively, the evaluating and selecting steps are performed for dynamic reselection of the particular HARQ-ACK codebook type to be used by a given UE, in association with the wireless communication network 10 carrying out ongoing communications with the UE 12.

Regarding the delay evaluation, the delay in one or more embodiments comprises a network transport delay within the network 10. The processing circuitry 56 is configured to evaluate the delay by evaluating a traffic loading or transport-capacity utilization within the wireless communication network 10 bearing on the transfer of the HARQ-ACK feedback to the processing entity that is responsible for downlink transmission control in the second cell. That is, in this example embodiment, “evaluating the delay” refers to an indirect or inferential evaluation in which the processing circuitry 56 evaluates one or more metrics that relate to delay. For example, measuring or otherwise determining the load conditions on one or more transport links that are involved in transferring HARQ feedback to the entity within the network 10 that uses it to control downlink transmissions in the involved cell represents one way of “evaluating the delay” that is experienced or expected for the transfer. Of course, the processing circuitry 56 may measure or otherwise determine the (transfer) delay directly—e.g., it may maintain an average or then-prevailing delay estimate used for making HARQ codebook selection decisions.

In a particular example, the processing circuitry 56 is configured to evaluate the delay by evaluating a first delay metric that is computed as an overall delay between a downlink transmission in the second cell for the UE 12 and receipt by the processing entity of corresponding HARQ-ACK feedback from the UE 12, as returned by the UE 12 in the first cell and transferred via the backhaul or sidehaul link to the processing entity. In this example, the overall delay includes the network transport delay as one component of the overall delay.

The two or more defined HARQ-ACK codebook types comprise, for example, a dynamic codebook type and a semi-static codebook type. The semi-static codebook type is based on structuring the HARQ-ACK feedback with a fixed number of bits and wherein the dynamic codebook type is based on structuring the HARQ-ACK feedback with a variable number of bits.

As another example, the processing circuitry 56 is configured to evaluate the delay by determining whether the delay exceeds a threshold, and wherein the processing circuitry 56 selects the particular HARQ-ACK codebook type by selecting the semi-static codebook type responsive to determining that the delay exceeds the threshold.

As another example configuration of the processing circuitry 56, in one or more embodiments, the processing circuitry 56 is configured to:
determine initial or updated values for one or more metrics, including any one or more of a delay metric, a throughput metric, and a load metric; and
select a Hybrid Automatic Repeat reQuest ACK (HARQ-ACK) codebook type to be used by a User Equipment (UE), in dependence on evaluating the one or more metrics;
wherein the delay metric accounts for transport delays within the network in scenarios where the network serves the UE using a Carrier Aggregation (CA) involving a first cell and one or more second cells, where the first cell and at least one of the one or more second cells are associated with different radio access points of the network, and where the UE uses the first cell to return HARQ-ACK feedback for all cells in the CA;
wherein the throughput metric accounts for effects of HARQ process exhaustion in the one or more second cells, on downlink throughput to the UE in the one or more second cells, and wherein longer transport delays increase a likelihood of HARQ process exhaustion in the one or more second cells; and
wherein the load metric accounts for uplink loading in the first cell that bears on resource availability for use by the UE in transmitting HARQ-ACK feedback.

The one or more metrics may further include a coverage metric that accounts for uplink quality of the UE in the first cell.

The one or more metrics include, for example, at least two metrics, and wherein selecting the HARQ-ACK codebook type to be used by the UE comprises making the selection in dependence on jointly evaluating the at least two metrics.

In an example of decision logic embodied in the processing circuitry 56 in one or more embodiments, longer transport delays, as reflected by the delay metric, bias HARQ-ACK codebook type selection towards the selection of a semi-static codebook type versus a dynamic codebook type. As another example, less sensitivity of the downlink throughput to the UE in the one or more second cells, as reflected by the throughput metric, biases HARQ-ACK codebook selection towards the selection of a semi-static codebook type versus a dynamic codebook type. In yet another example, greater uplink loading in the first cell, as reflected by the load metric, biases HARQ-ACK codebook selection towards the selection of a dynamic codebook type versus a semi-static codebook type. As a further example, poorer uplink channel conditions experienced by the UE in the first cell, as reflected by the coverage metric, bias HARQ-ACK codebook selection towards the selection of a dynamic codebook type versus a semi-static codebook type. Of course, the selection decision may consider multiple such metrics together, e.g., jointly, when making the codebook type selection decision.

As another example configuration of the processing circuitry 56, in one or more embodiments, the processing circuitry 56 is configured to:
determine initial or updated values for a coverage metric; and
select a Hybrid Automatic Repeat reQuest ACK (HARQ-ACK) codebook type to be used by a User Equipment (UE), in dependence on evaluating the coverage metric;
wherein the network serves the UE using a Carrier Aggregation (CA) involving a first cell and one or more second cells, where the first cell and at least one of the one or more second cells are associated with different radio access points of the network, wherein the UE uses the first cell to return HARQ-ACK feedback for all cells in the CA, and wherein the coverage metric reflects uplink channel conditions for the UE in the first cell.

Selecting the HARQ-ACK codebook type comprises, for example, classifying the uplink channel conditions as good or poor, and selecting a dynamic codebook type responsive at least in part to the uplink channel conditions being classified as poor. As a further example, selecting the HARQ-ACK codebook type comprises classifying the uplink channel conditions as good or poor, and selecting a static codebook type responsive at least in part to the uplink channel conditions being classified as good.

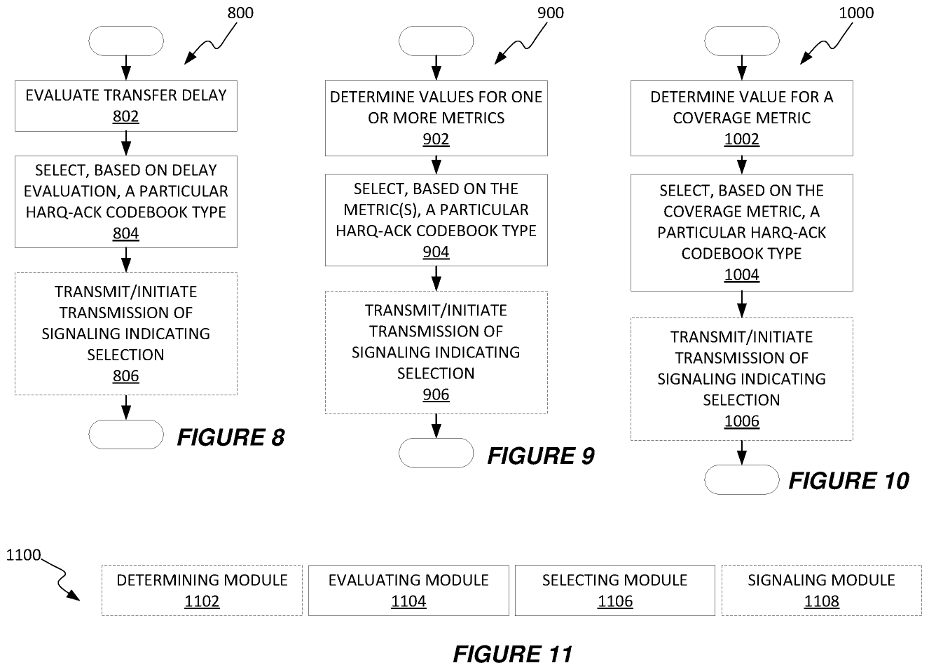

FIG. 8 illustrates a method 800 according to one embodiment, wherein the method is performed by a network node 24. The method 800 includes:
evaluating (Block 802) a delay associated with transferring Hybrid Automatic Repeat reQuest ACK (HARQ-ACK) feedback received from a User Equipment (UE) for a second cell of the wireless communication network, over a backhaul or sidehaul link of the wireless communication network to a processing entity that is responsible for downlink transmission control in the second cell, wherein the wireless communication network receives the HARQ-ACK feedback in a first cell of the wireless communication network that belongs to a Carrier Aggregation (CA) that is associated with the UE and further includes the second cell; and
selecting (Block 804), based on the delay evaluation, a particular HARQ-ACK codebook type from among two or more defined HARQ-ACK codebook types, for use by the UE in configuring the HARQ-ACK feedback.

The method 800 may further include the network node 24 transmitting or initiating the transmission of signaling indicating the selection (Block 806).

FIG. 9 illustrates a method 900 according to one embodiment, wherein the method is performed by a network node 24. The method 900 includes:
determining (Block 902) initial or updated values for one or more metrics, including any one or more of a delay metric, a throughput metric, and a load metric; and
selecting a Hybrid Automatic Repeat reQuest ACK (HARQ-ACK) codebook type to be used by a User Equipment (UE), in dependence on evaluating the one or more metrics.

The method 900 may further include the network node 24 transmitting or initiating the transmission of signaling indicating the selection (Block 906).

In one or more embodiments of the method:
the delay metric accounts for transport delays within the network in scenarios where the network serves the UE using a Carrier Aggregation (CA) involving a first cell and one or more second cells, where the first cell and at least one of the one or more second cells are associated with different radio access points of the network, and where the UE uses the first cell to return HARQ-ACK feedback for all cells in the CA;
the throughput metric accounts for effects of HARQ process exhaustion in the one or more second cells, on downlink throughput to the UE in the one or more second cells, and wherein longer transport delays increase a likelihood of HARQ process exhaustion in the one or more second cells; and
the load metric accounts for uplink loading in the first cell that bears on resource availability for use by the UE in transmitting HARQ-ACK feedback.

FIG. 10 illustrates a method 1000 according to one embodiment, wherein the method is performed by a network node 24. The method 1000 includes:
determining (Block 1002) initial or updated values for a coverage metric; and
selecting (Block 1004) a Hybrid Automatic Repeat reQuest ACK (HARQ-ACK) codebook type to be used by a User Equipment (UE), in dependence on evaluating the coverage metric.

The method 1000 may further include the network node 24 transmitting or initiating the transmission of signaling indicating the selection (Block 1006).

In an example arrangement, the network 10 serves the UE 12 using a Carrier Aggregation (CA) involving a first cell 34-1 and one or more second cells 34 (e.g., 34-2, 34-3, . . . ), where the first cell 34 and at least one of the one or more second cells 34 are associated with different radio access points of the network (e.g., different TRPs 22), wherein the UE 12 uses the first cell 34-1 to return HARQ-ACK feedback for all cells 34 in the CA, and wherein the coverage metric reflects uplink channel conditions for the UE 12 in the first cell 34-1.

FIG. 11 illustrates another example embodiment of a network node 24, where the network node 24 comprises a set 1100 of one or more processing modules or units, such as may be realized functionally via the execution of stored computer program instructions by one or more microprocessors or other digital processing circuitry.

The set 1100 includes a determining module 1102 that is configured to determine a metric or metrics for use in selecting which type of HARQ-ACK codebook a UE 12 uses. One or more metrics may be applicable in common to more than one UE 12, e.g., metrics relating to loading within a cell or on a transport link of the network 10. Other metrics may be specific to individual UEs 12, e.g., uplink channel conditions. It should be understood that the network node 24 may perform codebook-type selection for multiple UEs 12 and may maintain UE-specific metrics for making such decisions.

The set 1100 further includes an evaluating module 1104 that is configured to evaluate the metric(s) associated with one or more UEs 12, for deciding the codebook type(s) to be selected for the UE(s) 12, and a selecting module 1106 to make the selection(s) in dependence on the evaluation results. The set 1100 may further include a signaling module 1108, for transmitting signaling to the UE 12 to indicate the decision, or for initiating the transmission of such signaling.

Broadly, the embodiments described herein include methods or apparatus, such as may be performed by or implemented in one or more network nodes in or communicatively coupled with a wireless communication network. Example nodes include one or more nodes in a Radio Access Network (RAN) portion of the network, a Core Network (CN) portion of the network, or elsewhere, such as in a cloud-computing or data-center facility. An example network node is a radio network node, such as a gNB configured for operation in a 5G NR RAN.

Embodiments also include a radio network node comprising processing circuitry and power supply circuitry. The processing circuitry is configured to perform any of the steps of any of the embodiments described above for the radio network node. The power supply circuitry is configured to supply power to the radio network node.

Embodiments further include a radio network node comprising processing circuitry. The processing circuitry is configured to perform any of the steps of any of the embodiments described above for the radio network node. In some embodiments, the radio network node further comprises communication circuitry.

Embodiments further include a radio network node comprising processing circuitry and memory. The memory contains instructions executable by the processing circuitry whereby the radio network node is configured to perform any of the steps of any of the embodiments described above for the radio network node.

More particularly, the apparatuses described above may perform the methods herein and any other processing by implementing any functional means, modules, units, or circuitry. In one embodiment, for example, the apparatuses comprise respective circuits or circuitry configured to perform the steps shown in the method figures. The circuits or circuitry in this regard may comprise circuits dedicated to performing certain functional processing and/or one or more microprocessors in conjunction with memory. For instance, the circuitry may include one or more microprocessor or microcontrollers, as well as other digital hardware, which may include digital signal processors (DSPs), special-purpose digital logic, and the like. The processing circuitry may be configured to execute program code stored in memory, which may include one or several types of memory such as read-only memory (ROM), random-access memory, cache memory, flash memory devices, optical storage devices, etc. Program code stored in memory may include program instructions for executing one or more telecommunications and/or data communications protocols as well as instructions for carrying out one or more of the techniques described herein, in several embodiments. In embodiments that employ memory, the memory stores program code that, when executed by the one or more processors, carries out the techniques described herein.

Among the example advantages provided by the disclosed basis/bases for selecting the type of HARQ-ACK codebook used by a UE, are the following items, which are described using 3GPP/5G NR terminology:
Maximize the gains from carrier aggregation in the case of non-co-located gNBs with long inter-gNB link delay;
Minimize the impact on PCell UL capacity in the case of short inter-gNB link;
Ensure reliable HARQ feedback of SCell data when the UE is located at poor PCell UL coverage while considering UE transmit power constraints; and
Allow the network operator to strike a balance between CA gains and performance of local non-carrier aggregated UEs connected to SpCell, especially in the context of busy cells.

As an example of the metrics, also referred to as “performance metrics,” that may be considered by a network node 24 for selecting the type of HARQ-ACK codebook to be used by a UE 12, include the following example metrics.

### Metric 1 (F1): DL HARQ Delay

DL HARQ delay here indicates a time span of a DL HARQ process, which is used to carry a DL data transmission via SCell carrier, i) start from being allocated by the SCell DL scheduler of the gNB, ii) transmitted over the air, iii) UE receives data and sends the HARQ feedback via gNB desired UL slot and radio resources of the SpCell, and then iv) the received by SpCell that relay it to SCell. By then, the HARQ process is ready to be scheduled for next DL data transmission.

A set of K1s are to be designed based on the SpCell TDD pattern, inter-gNB delay as the one-way delay between SpCell and candidate SCell and HARQ-ACK codebook type being used.

In general, semi-static HARQ-ACK codebook requires less coordination between SpCell and SCell on the DAI values and number of DL Tx toward HARQ bits decoding. That results in a smaller HARQ delay compared to using dynamic HARQ-codebook under the same inter-gNB delay.

The details are described in different embodiments.

### Metric 2 (F2): HARQ Process Exhaustion Impact to Potential CA UE DL Throughput on SCell

HARQ-ACK process ID exhaustion results from there being a long time span of HARQ process usage for one DL data transmission can result in a lower single user peak throughput. That can be an obvious issue on UEs DL data transmission on SCell with a long inter-gNB delay. Typically, Dynamic HARQ-ACK codebook requires an increased feedback time at long inter-gNB delay due to the needed communication between SpCell and SCell for DAI coordination and/or exact HARQ-bits to be decoded. On the other hand, Semi-static HARQ-ACK codebook does not require coordination between SpCell and SCell and thus, a shorter feedback time can be adopted at long inter-gNB delay.

### Metric 3 (F3): SpCell PUCCH Resource Usage

For dynamic HARQ-ACK codebook, with a long inter-gNB interaction delay, DAI value coordination between SpCell and SCells will be very difficult to achieve while ensuring in-order-grants unless the slot allocation of UE at each CC is predetermined. In order to achieve scheduling flexibility, subset of UL slots arranged for HARQ-ACKs on SpCell or SCells respectively is a valid option for avoiding the need for DAI coordination.

On the other hand, dynamic HARQ-ACK codebook may show better PUCCH resource usage due to:
More flexibility on using available PUCCH resources such as resources with PUCCH formats 0 or 1 (PF0/PF1) that consume much less radio resources but only take up to 2 HARQ-ACK bits;
K1 range, which reflects PDCCH monitor window, can be relatively flexible as they are not necessarily tied to the size of HARQ-ACK bits.

For semi-static codebook, the codebook size is fixed based on the PDCCH monitor window and number of aggregated carriers. Therefore,
If the fixed codebook size is larger than 2, PUCCH format 2, format 4 or format 3, which consume more radio resources, have to be chosen;
In order to maintain a scalable HARQ-ACK codebook size, the PDCCH monitor window and K1 value ranges shall be configured with small values.
Small PDCCH monitor window could cause constantly needing PUCCH resources to carry HARQ-ACK FB on sporadic DL transmissions for the UE. Scheduler may need to wisely manage PUCCH resources especially when the cell load is heavy with many connected users.
Heavier PUCCH usages will result in reserving more UL PRBs for PUCCH, which degrades SpCell UL throughput due to smaller number of PRBs left for PUSCH.

Under light cell load, both codebooks provide similar PUCCH load; and thus, less impact on SpCell UL throughput. On the other hand, dynamic codebook has a higher advantage in the case of relatively heavy cell load case.

In the uplink channels, PUSCH impact due to higher number of bits in feedback can also be included in this cost as it has some impact in processing cost as well as coverage.

### Metric 4 (F4): SpCell UL Coverage

If the UE is at a good uplink channel condition of the SpCell, higher modulation and coding rates can be used, resulting in transmitting a large codebook size with less PRBs.

If UE moves towards the cell edge, then use of a dynamic HARQ-ACK codebook by the UE provides the SCell with better control of DL data transmission, where the involved scheduler can easily adapt the max HARQ_ACK bits based on uplink channel conditions, thus can be done by controlling number of DL data transmission slots whose HARQ feedback is expected to be on the same UL slot of SpCell.
This automatically fits general practice for balancing DL/UL transmissions.
With semi-static codebook, before reaching to poor uplink channel conditions, the gNB needs to send RRC reconfiguration to the UE for either reducing the number of aggregated carriers or reducing the PDCCH monitoring window.
If there are PUCCH resources with potential more HARQ bits allowed (e.g., PUCCH format 3 with multiple PRBs), scheduler selects those as the HARQ-feedback for the UE.

### Initial HARO-ACK Codebook Type Selection

The HARQ-ACK codebook used by a UE is selected based on which type achieves (or is estimated to achieve) a higher combined utility, as a function of one or more of the above four metrics. In at least one embodiment, the type selection considers all four metrics. The utility function can be defined by the network operator in different ways that reflect the importance of each metric. The importance may also consider the priority of some UEs, whose performance can be optimized by selecting a certain HARQ-ACK codebook type.

### Runtime (Dynamic or Repeated) Optimization of HARO-ACK Codebook Type

While a UE maintains its connection status with the network and is active, the UE's channel conditions may change and conditions in the network may change, e.g., cell loading may change, transport-network loading w/in the network may change, etc. Changing conditions may result in the currently-selected codebook type for the UE being suboptimal. Based on monitoring such changes and evaluating whether the current codebook type selection for the UE is the best, according to whatever cost function is configured for the evaluation, the network may trigger a Physical Uplink Control Channel (PUCCH) reconfiguration, for changing the type of HARQ-ACK codebook selected for use by the UE.

Profiles of system and UE traffic/channel conditions can be changed from time to time, such as:
Inter-gNB delay due to traffic loads on transport networks (cell based);
   A longer delay may increase preference towards semi-static codebook, and vice versa;
Traffic DL/UL portfolios that the UE is using on SpCell (cell based);
   Allow more or fewer PRBs for PUCCH, where more PUCCH PRBs may increase preference towards semi-static CB and vice versa;
Traffic load of the cell that the UE is used as SCell (cell based);
   Light DL traffic load may increase preference towards dynamic CB and vice versa;
CA UE's traffic volume and data delay tolerance (UE based);
   f the data can tolerate longer delays by until feedback is forwarded to SCell;
CA UE's SpCell UL channel condition (UE based); or
   Moving UE may cause channel conditions changes—with UEs moving towards the SpCell edge, dynamic CB provides more flexible link adaptations on HARQ bits for reliable UE feedback receptions.

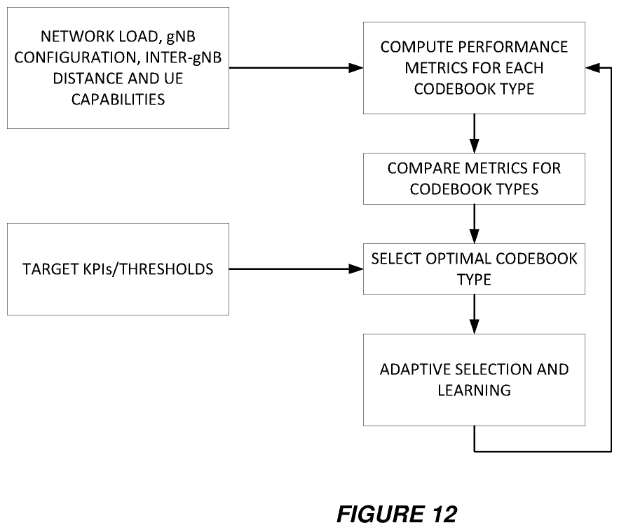

FIG. 12 illustrates another embodiment of a method of codebook type selection, where the selection may be understood as an “inter-gNB link aware HARQ-ACK codebook selection” process. The method includes the computation of the above-described performance metrics, based on obtaining current values of the relevant parameters, such as network load, gNB configuration, inter-gNB distance (as between the gNBs involved in the transfer of HARQ feedback), UE capabilities regarding HARQ operations, etc.

The method further includes comparing the metrics, as computed for each codebook type, and selecting the codebook type that is “optimal” in view of the metric comparison. Here, “optimal” denotes, for example, the best one among the codebook types for which metrics were computed and evaluated.

The method may further include adaptive selection and learning, such as where the network adapts its decision-making and/or metric computations, in dependence on tracking the results of its codebook-type selection decisions. Results here may be expressed in terms of UE performance and/or overall network performance.

### Codebook Type Selection Based on UE Throughput and Network Load

This embodiment demonstrates a possible implementation for the HARQ delay impact, UE throughput, and the load on the UL of the SpCell for each candidate codebook type (i.e., Metrics 1, 2 and 3 according to the earlier metric-definition examples). The approach uses a utility function to combine the considered metrics—the throughput and load related metrics—to recommend the optimal codebook type as detailed below. Metric 4, the one relating to uplink coverage-uplink channel conditions of the UE for which the decision is being made—is not considered here. Or, put differently, this example may be understood as assuming that the UE has good uplink coverage.

Example Details for Metric 1 Compute time span from one DL transmission over a remote SCell to UE's HARQ-ACK received at the SCell is denoted as total HARQ delay t_{harqSpan} and computed as following based on how the system is designed with selected HARQ-ACK codebook type:
Semi-static HARQ-ACK codebook is used:

$${t}_{harqSpan} [ ms ] = K {1}_{max} [ ms ] + {D}_{gnb} [ ms ] + {t}_{proc} [ ms ]$$

Dynamic HARQ-ACK codebook is used without UCI on PUSCH:

$${t}_{harqSpan} [ ms ] = max ( K {1}_{max} , {D}_{gnb} + K {1}_{max} - K {1}_{min} ) ) [ ms ] + {D}_{gnb} [ ms ] + {t}_{proc} [ ms ]$$

Kₘᵢₙ>=Dgnb
Dynamic HARQ-ACK codebook is used with UCI on PUSCH:

$${t}_{harqSpan} [ ms ] = max ( K {1}_{max} , {D}_{gnb} + K {1}_{max} - K {1}_{min} ) ) [ ms ] + {D}_{gnb} [ ms ] + K 2 + {t}_{proc} [ ms ]$$

$${K}_{min} >= {D}_{gnb} + K 2$$

### Where:

K1 is the time offset between PDSCH (via SCell) transmission to PUCCH/PUSCH (via SpCell) with UE's HARQ-ACK feedbacks;
K1 can be configured as a subset of up to 8 different values used on SCell DL Tx, where K1ₘₐₓ and K1ₘᵢₙ as max and min K1 values applied on DL transmissions in SCell;
D_{gnb} is the inter-gNB delay, as the one-way delay between PCell and candidate SCell
t_{proc} is the processing time consumed by physical layer;
K2 is the time offset between slot with DCIO to slot with PUSCH transmission at SpCell that may carry HARQ-ACK feedback for the SCell.

### Example Details for Metric 2 (HARO Delay Impact on Single User's DL Peak Throughput on SCell)

Single user peak throughput degradations due to HARQ process exhaustion at SCell are denoted by L and computed as following

$$L [ \% ] = 100 \% * max ( 0 , ( {t}_{harqSpan} / {t}_{slot} * {r}_{D} - {N}_{HP} ) / ( {t}_{harqSpan} / {t}_{slot} * {r}_{D} ) )$$

Where:
tₛₗₒₜ: duration of slot (TTI) which depends on numerology
r_{D}: ratio of DL slots to the total number of slots in the t_{harqSpan} window
N_{HP}: maximum number of HARQ process that can be used to transmit data to the same UE from the same carrier (max number=16 according to 3GPP)
If the SCell has multiple CA users and locally connected users to share the cell resources for DL data transmission, the cell throughput will be less impacted by single UE HARQ process exhaustions since each user get a fraction of the DL slots for the DL data transmission. Thus, the loss is recomputed as follows

$$Ld [ \% ] = 100 \% * max ( 0 , ( {t}_{harqSpan} / {t}_{slot} * {r}_{D} - {N}_{HP} ) / ( {t}_{harqSpan} / {t}_{slot} * {r}_{d} ) )$$

Where r_{d}<r_{D} due to multiple users (local users or CA users using the SCell DL radio resources for data transmission). Where all users are competing for total DL slots r_{D} to transmit DL data. Assume that there are in average N users having DL data in buffer and average M users share the resources in the same DL slot (N>M), rd can be estimated as rd=(M/N)*r_{D}.

### An Example Utility Function for Selecting the HARO-ACK Codebook Type

If the UE in question has good UL coverage in the SpCell such that transmitting a larger size of HARQ-ACK codebook is not an issue, the codebook selection can be determined based on UE throughput expectations and cell loading status. This approach recognizes that one or more codebook types may be larger than one or more other codebook types—i.e., the HARQ feedback transmission from the UE will generally be larger for one codebook type than for another codebook type.

Single user peak throughput degradations for UE using dynamic HARQ-ACK codebook (with/without UCI on PUSCH depending on UL traffic demand for the user) denoted as Ld_d, or semi-static HARQ-ACK codebook, denoted as Ld_s.
Cell load is considered in certain period as the average number of connected UEs at the cell (using this cell as SpCell or SCell) with DL data to be transmitted, indicated as NHP in metric 2;
Ld_s and Ld_d are calculated by using formula indicated in metric 1 and metric 2;
f(N)≥0 is a function for additional cell loading influences other than factor of HARQ Process exhaustion and UE DL assignment reflected in Ld, such as SpCell PUCCH availabilities, indicated in metric 3, caused throughput degradations; and
If Ld_d>(Ld_s+f(N)), semi-static codebook is selected; else dynamic codebook is selected.

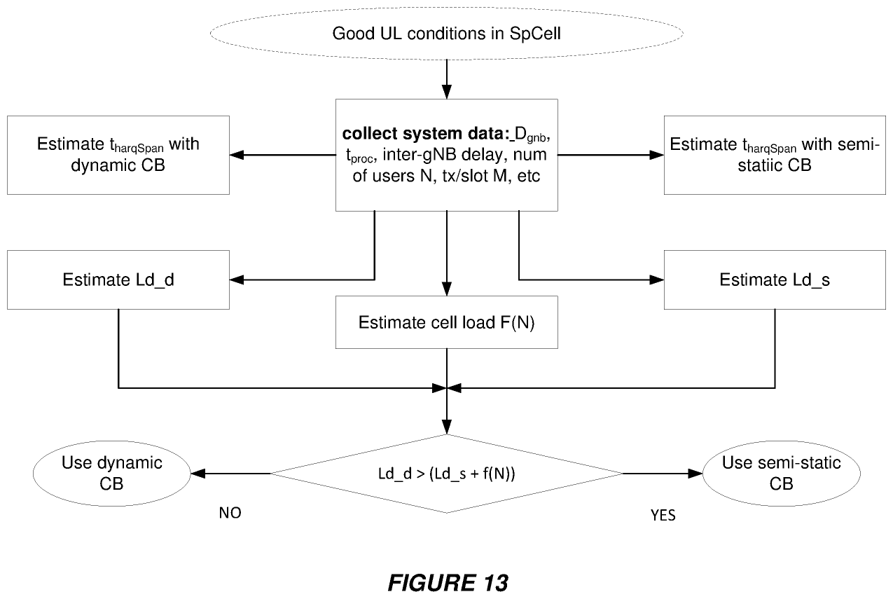

FIG. 13 depicts an example method of basing codebook type selection based on UE throughput and network load.

### Codebook Type Selection Based on SpCell UL Coverage

If a UE starts moving out of good UL coverage in the SpCell, evaluation of HARQ-ACK codebook reception is required with a different set of selection criteria as explained in Metric 4 (F4).
Evaluate PUSCH gating risk, to safely receive HARQ-ACK bits and keep the corresponding DL traffic flow. The PRBs reported by UE's power headroom (PH) should be able to carry the required HARQ-ACK bits plus about n % current DL total throughput (Th_{updl}), where n % is the general user UL/DL traffic ratio based on the statistics of the traffic the user is using.

$$PH ( PRBs ) > PRBs ( HARQ - bits + n \% * {Th}_{updl} )$$

If PH (PRBs)<(PRBs (HARQ-bits+n %*Th_{updl})+delta), where delta >=0 for leaving a room in the case of deteriorating PUSCH channel condition in the near-term.
   If UE is using dynamic HARQ-ACK codebook, keep using it and reduce number of DL data transmissions
   Else (UE is using semi-static HARQ-ACK codebook)
      Reducing the number of SCells that may lead to
      HARQ-bits_{new} and Th_{updl_new} are to be reduced by percentages of the SCell shares.
      Re-estimate to ensure that UE's power headroom can handle the resulted HARQ-bits_{new} and Th_{updl_new}
      If the above condition can be achieved before minimal needed SCells to be kept, reconfigure UE with SCell deductions but semi-static codebook is kept
      Else, reconfigure UE with using dynamic codebook
   End if
Else PUSCH condition of SpCell has been obviously improved with PH (PRBs)>>PRBs (HARQ-bits+n %*Thup_{d}i)+delta
   If UE is using dynamic HARQ-ACK codebook,
      Consider possibly to change to semi-static codebook as indicated in Embodiment 1
   If dynamic codebook is kept, allow more # of DL Transmissions
   Else (UE is using semi-static HARQ-ACK codebook)
      Consider possibly increase # of SCells for further increasing DL throughputs End if
End if
Evaluate PUCCH gating risk, to safely receiving HARQ-ACK bits with desired PUCCH recoding error rate (e.g., Th_{bler}=1% BLER) with current PUCCH SINR measurement. Large number of HARQ-bits requires higher PUCCH SINR of UE's UL channel conditions for keeping the BLER under such threshold.
   If BLER (HARQ-bits, PUCCH SINR)>Th_{bler}+delta, where delta>=0 for leaving a room for PUCCH channel condition to be poorer in short future time with the same trend.
      If UE is using dynamic HARQ-ACK codebook, keep using it and reduce number of DL data transmissions.
      Else (UE is using semi-static HARQ-ACK codebook)
         Reducing some of SCells that may lead to
         Smaller HARQ-bits_{new} due to the codebook size reduced.
         Re-estimate to ensure
         BLER (HARQ-bit_{snew}, PUCCH SINR)<Thier+delta
         If the above condition can be achieved before minimal needed SCells to be kept, reconfigure UE with SCell deductions but semi-static codebook is kept
         Else, reconfigure UE with using dynamic codebook
      End if
   Else SpCell PUCCH condition has obviously improved with BLER (HARQ-bits, PUCCH SINR)<<(Th_{bler}+delta)
      If UE is using dynamic HARQ-ACK codebook,
         Consider possibly to change to semi-static codebook as indicated in Embodiment 1
         If dynamic codebook is kept, allow more # of DL Transmissions.
      Else (UE is using semi-static HARQ-ACK codebook)
         Consider possibly increase # of SCells for further increasing DL throughputs
      End if
   End if
If different estimations are resulted from PUCCH and PUSCH, a more conservative result is to be taken as in the following order:
   Reconfig with dynamic CB or reconfig with reduced #CC or reduce #DL TX;
   Keep current setting
   Reconfig with semi-static CB or reconfig with increased #CC or increase #DL TX

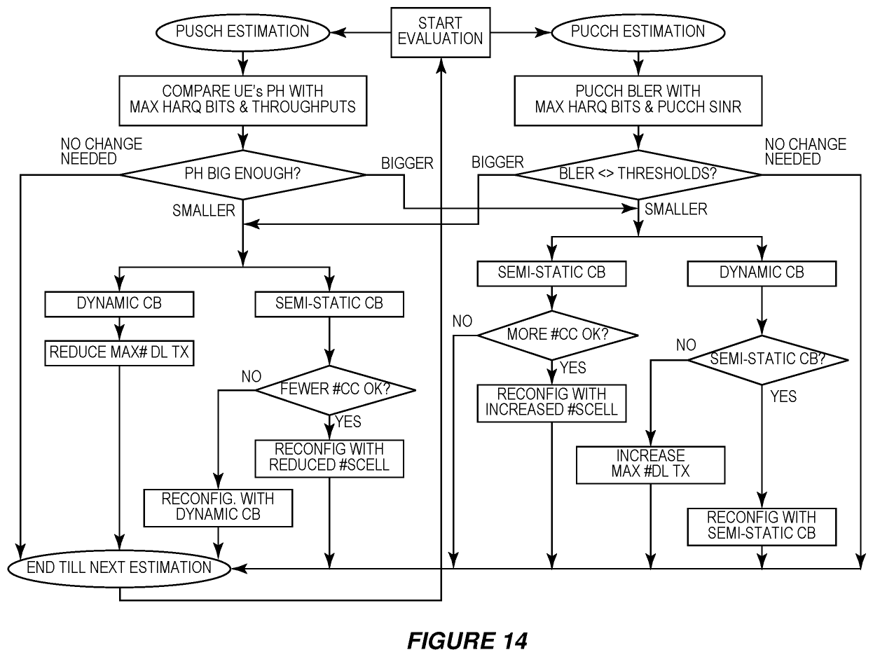

FIG. 14 illustrates one embodiment of a method for codebook type selection based on the SpCell UL coverage of a UE.

### Codebook Type Selection Based on Threshold(s)

In this embodiment, the factors that impact the value of the performance metrics F1, F2 and F3 are considered directly in the selection of HARQ-ACK codebook type. Where in the case of high dynamics in the network, calculating the metric formulas in embodiments 1 and 2 might become challenging.

Metric F1 (HARQ delay) is directly proportional to the inter-gNB delay.

Metric F2 (HARQ process exhaustion) is inversely proportional to the contention delay at SCell. Where the more UEs are in the SCell, the less the impact of HARQ process exhaustion is on the user throughput. It has to be noted that other contention delay factors can be considered instead such as the number of slots (where the users have been waiting in the scheduling queue) or the number of slots the user get access to the air interface resources.

Metric F3 (SpCell load) is directly proportional to the SpCell load.

This implies that, if the inter-gNB delay is small or the number of users is large to an extent that the K1 value used by dynamic HARQ-ACK codebook is not impacting the throughput or delay, then that HARQ-ACK codebook can be used. In addition, if the SpCell UL capacity cannot afford the large number of HARQ bits needed by the Semi-static HARQ-ACK codebook type, and thus dynamic need to be selected. This is captured in the following condition:
IF (Inter-gNB delay<Thresh_1 OR number of UEs at SCell>Thresh_2 OR SpCell UL capacity<Thresh_3)
Select dynamic HARQ-ACK codebook type
ELSE
Select Semi-static HARQ-ACK codebook
ENDIFs

Where the values of Thresh_1, Thresh_2 and Thresh_3 can be computed empirically based on system-level simulations (e.g., as depicted in FIG. 3) or lab measurements.

### HARQ-ACK Codebook Type Switching (Dynamic Reselection of Codebook Type)

This embodiment considers the dynamic changes in the first three metrics (F1, F2, F3) as well as the fourth metric (F4) value, in order to assess the optimality of the current selected HARQ-ACK codebook type. Thus, this embodiment tries to capture and model the dynamics in the network in order to minimize the switching between the codebook types (i.e., minimize reconfiguration and signaling overhead for changing the type of HARQ-ACK codebook used by a UE). Implementation details include:
SpCell monitors the following events for each CA UE:
   E1: Change in inter-gNB delay: the measured inter-gNB delay D became smaller or larger than the last stored value.
   E2: Change in the number of users: the number of users N connected to SpCell only, SCell only, or CA users connected to both cells have increased or decreased compared to the last stored value
   E3: Change in radio conditions: the average channel quality or signal strength S increased or decreased compared to the last stored value
In the case of any of the above events:
   SpCell can re-evaluate the selected HARQ-ACK codebook type using the approaches in embodiment 1, 2 or 3.
If the frequency of occurrence of these events became very high; the SpCell can select HARQ-ACK codebook type as following to minimize the switching as illustrated below:

$$IF \vert D ( t ) - D ( t - 1 ) \vert < T \qquad E1$$

Inter-gNB link delay is varying so fast over-time, then
Select semi-static codebook with a fixed K1 value; since dynamic HARQ-ACK codebook with a suitable small K1 value will be very challenging (i.e., optimize F₁)

$$ELSEIF \vert N ( t ) - N ( t - 1 ) \vert > M \qquad E2$$

Large variation in the number of users (and the system load)
Select dynamic codebook; to avoid impacting the SpCell UL resources when large number of users get connected (i.e., Optimize F₃), and also HARQ process exhaustion is of occurrence probability (i.e., no impact on F₂)

$$ELSEIF \vert S ( t ) - S ( t - 1 ) \vert > L \qquad E3$$

Large variation in UE radio conditions; and thus, hard to adapt the number of activated SCells
Use dynamic HARQ-ACK codebook; to avoid excessive RRC reconfig.
ELSEIF E1 AND NOT(E2 or E3)
   Select semi-static HARQ-ACK codebook
ELSE
   Select dynamic HARQ-ACK codebook
ENDIF

The operator selects T, M and L to achieve a target KPI.

### Learning-Based HARO-ACK Codebook Type Selection

In this embodiment, the network node(s) carrying out codebook type selection adopt machine learning techniques to estimate the performance metrics and select the optimal HARQ-ACK codebook.
Supervised learning
   Training phase:
      In this phase, the system tries to learn the relation between the different parameters and output KPIs under different codebook types.
      Input parameters: Using a system-level simulation, configure scenarios with different values for each of the below key parameters:
         Inter-gNB delay D={d1, d2, d3, d4, . . . }
         Number of UEs in SpCell N={n1, n2, n3, . . . }
         User speed S={s1, s2, s3, . . . }
         Channel conditions (e.g., SINR) C={c1, c2, c3, . . . }
         User traffic load L={l1, l2, . . . }
      Output Key Performance Indicators (KPIs): Define target KPI as one or a combination of the following
         UE throughput: R1
         Data transfer delay: R2
         BLER: R3
      Different scenarios can be created by varying the input parameters and record the output parameters while configuring dynamic and semi-static, one at a time, as illustrated below in scenario 1:
         Scenario 1_{dynamic}:
         I/P: {d1,n1,s1,c1,l1}
         Codebook type=dynamic
         O/P: {R1_{1,dynamic}, R2_{1,dynamic}, R3_{1,dynamic}}
         Scenario 1_{semi-static}:
         I/P: {d1,n1,s1,c1,l1}
         Codebook type=semi-static
         O/P: {R1_{1,semi-static}, R2_{1,semi-static}, R3_{1,semi-static}}
      This can be done in a controlled lab environment or a system level simulator
      Use a supervised machine learning technique such as a decision tree or random forest to model the relation between recorded input/output parameters for each codebook type.
   Model Deploying Phase:
      The trained model can be used in a live network.
      Based on the observed input parameters, select the codebook type with the maximum output KPIs under the current input parameters observed in a real-network.
   Reinforcement learning
      The trained model can be further optimized in the field by adopting reinforcement learning in the case of having new input conditions that were not considered in the training phase.
      This can be done by the following steps:
      Choose the closest scenario who input parameters are close to the current network KPIs. For e.g., using the following formula

| | |
|---|---|
| ◯ | RMSEₓ = Σᵢ(Iᵢ − l̅ₗ̅)², where lᵢ is the input |
| | parameter value i in scenario x, and l̅ₗ̅ is the |
| | currently measured value in the network. |
| ◯ | Best matching scenario y= argmin RMSEₓ |
| ◯ | IF f(R1_{y, semi-static}, R2_{y, semi-static}, R3_{y,semi-static}) > |
| | f(R1_{y, dynamic}, R2_{y, dynamic}, R3_{y, dynamic}) |

| | |
|---|---|
| ▪ | IF NOT(exploration timer) |

| | |
|---|---|
| ● | Select semi-static HARQ-ACK |
| | codebook |

| | |
|---|---|
| ▪ | ELSE |

| | |
|---|---|
| ● | Select dynamic HARQ-ACK |
| | codebook |

| | |
|---|---|
| ▪ | ENDIF |

| | |
|---|---|
| ◯ | ELSE |

| | |
|---|---|
| ▪ | Select dynamic HARQ-ACK codebook |

| | |
|---|---|
| ◯ | ENDIF |

| | |
|---|---|
| ● | Record the output KPIs (and selected codebook type) and |
| | store them for future usage. |

Here, f(R1, R2, R3) is a utility function that accounts for the three metrics and can be formulated as:

$$f ( R 1 , R 2 , R 3 ) = R 1 * R 3 * ( 1 - \frac{max ( 0 , max Delay - R 2 )}{( max Delay - R 2} )$$

This results in 0 value if the delay (i.e., R2) is less than the maxDelay value.

Broadly, the various embodiments of codebook type selection described herein provide multiple advantages, such as maximizing the gain of carrier aggregation for a UE, especially when the CA involves non-co-located gNBs, based on providing for improved selection of the HARQ-ACK codebook type used by the UE. A set of observed and calculated metrics provides the basis for the improved type selections, resulting in superior performance in terms of throughput and air interface usage in terms of efficiency. The approach flexibly provides for initial and run-time decisions for network, on a per-UE basis, for optimized codebook type selections, considering UE prioritization and capabilities versus air interface usage.

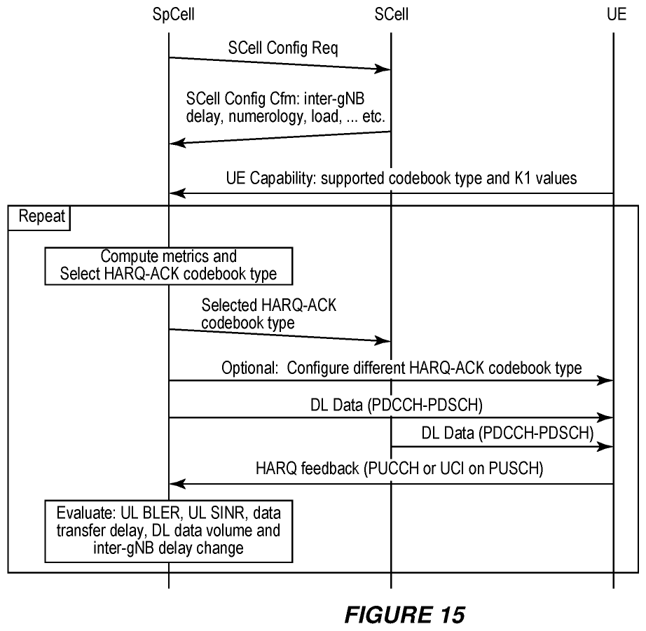

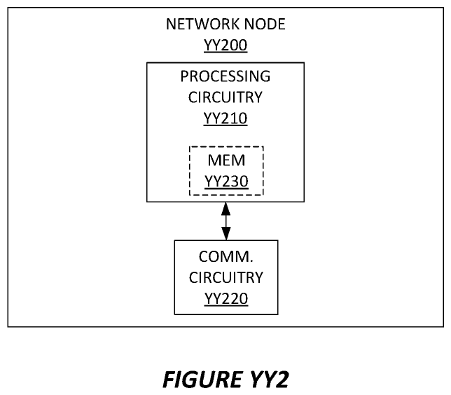

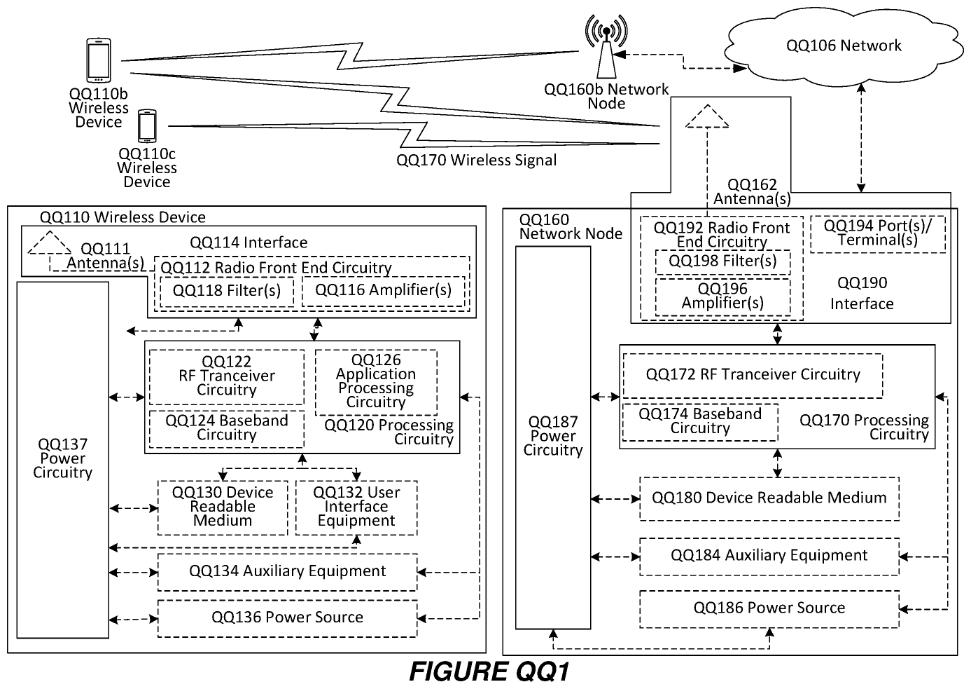

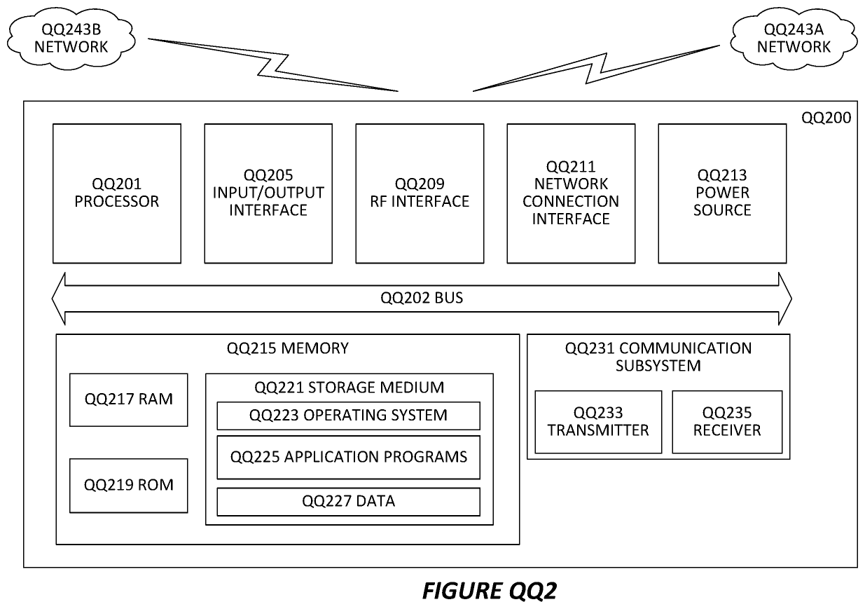

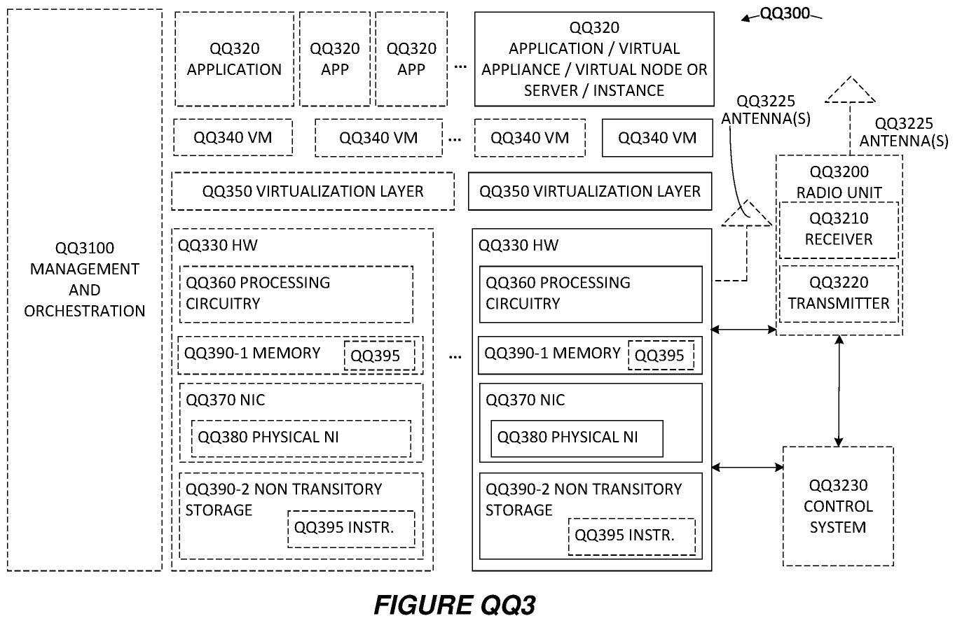

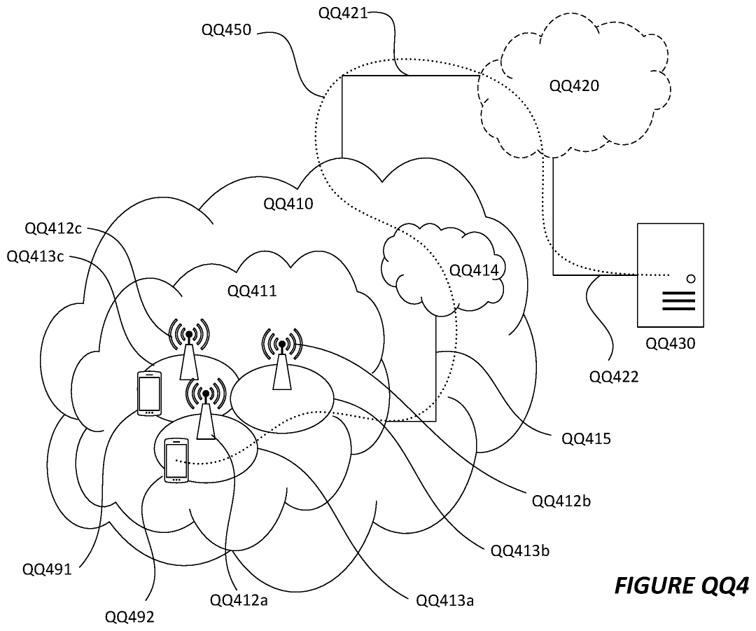

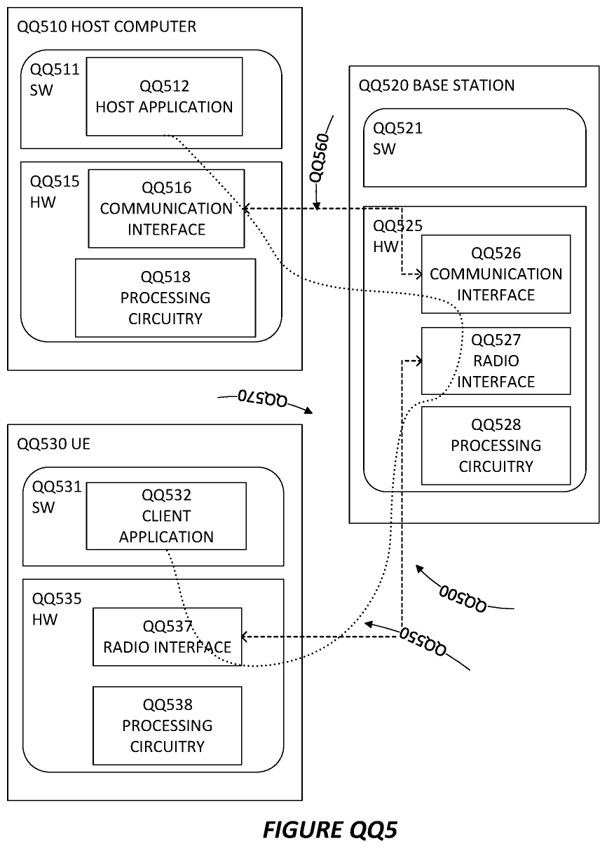

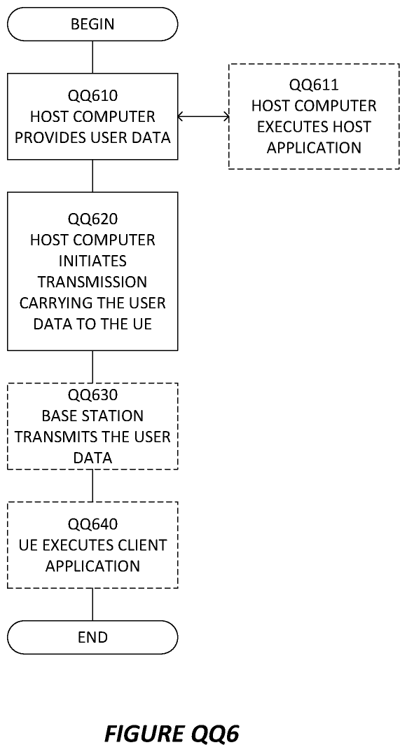

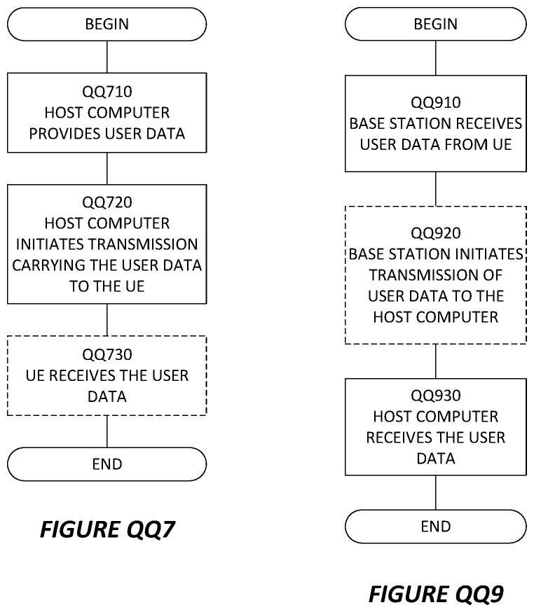

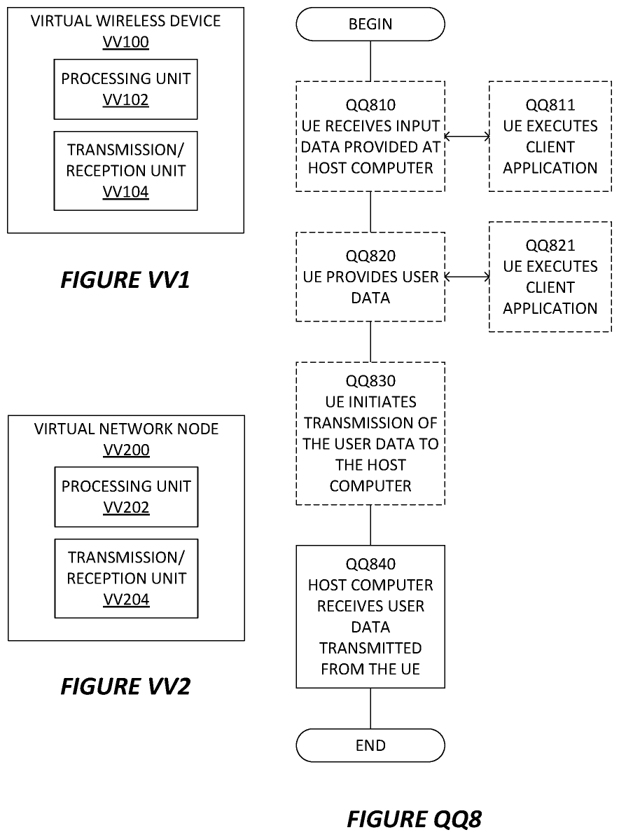

FIG. 15 depicts an example signal flow, as between a SpCell and a SCell in a CA used for a UE, where non-co-located TRPs 22 respectively provide the SpCell and the SCell.

Turning to further example implementation details. FIG. YY2 illustrates a network node YY200 as implemented in accordance with one or more embodiments. In one or more embodiments, the network node YY200 is an example of the network node 24 discussed above. As shown, the network node YY200 includes processing circuitry YY210 and communication circuitry YY220. The communication circuitry YY220 is configured to transmit and/or receive information to and/or from one or more other nodes, e.g., via any communication technology. The processing circuitry YY210 is configured to perform processing described above, such as by executing instructions stored in memory YY230. The processing circuitry YY210 in this regard may implement certain functional means, units, or modules.

Those skilled in the art will also appreciate that embodiments herein further include corresponding computer programs.

A computer program comprises instructions which, when executed on at least one processor of an apparatus, cause the apparatus to carry out any of the respective processing described above. A computer program in this regard may comprise one or more code modules corresponding to the means or units described above.

Embodiments further include a carrier containing such a computer program. This carrier may comprise one of an electronic signal, optical signal, radio signal, or computer readable storage medium.

In this regard, embodiments herein also include a computer program product stored on a non-transitory computer readable (storage or recording) medium and comprising instructions that, when executed by a processor of an apparatus, cause the apparatus to perform as described above.

Embodiments further include a computer program product comprising program code portions for performing the steps of any of the embodiments herein when the computer program product is executed by a computing device. This computer program product may be stored on a computer readable recording medium.

Additional embodiments will now be described. At least some of these embodiments may be described as applicable in certain contexts and/or wireless network types for illustrative purposes, but the embodiments are similarly applicable in other contexts and/or wireless network types not explicitly described.

Although the subject matter described herein may be implemented in any appropriate type of system using any suitable components, the embodiments disclosed herein are described in relation to a wireless network, such as the example wireless network illustrated in Figure QQ1, which may be understood as a more detailed depiction of the network 10 discussed earlier herein, in one or more embodiments of the network 10.

For simplicity, the wireless network of FIG. QQ1 only depicts network QQ106, network nodes QQ160 and QQ160b, and wireless devices QQ110, QQ1 Ob, and QQ1 Oc. In practice, a wireless network may further include any additional elements suitable to support communication between wireless devices or between a wireless device and another communication device, such as a landline telephone, a service provider, or any other network node or end device. Of the illustrated components, network node QQ160 and wireless device QQ110 are depicted with additional detail. The wireless network may provide communication and other types of services to one or more wireless devices to facilitate the wireless devices' access to and/or use of the services provided by, or via, the wireless network.

The wireless network may comprise and/or interface with any type of communication, telecommunication, data, cellular, and/or radio network or other similar type of system. In some embodiments, the wireless network may be configured to operate according to specific standards or other types of predefined rules or procedures. Thus, particular embodiments of the wireless network may implement communication standards, such as Global System for Mobile Communications (GSM), Universal Mobile Telecommunications System (UMTS), Long Term Evolution (LTE), Narrowband Internet of Things (NB-IoT), and/or other suitable 2G, 3G, 4G, or 5G standards; wireless local area network (WLAN) standards, such as the IEEE 802.11 standards; and/or any other appropriate wireless communication standard, such as the Worldwide Interoperability for Microwave Access (WiMAX), Bluetooth, Z-Wave and/or ZigBee standards.

Network QQ106 may comprise one or more backhaul networks, core networks, IP networks, public switched telephone networks (PSTNs), packet data networks, optical networks, wide-area networks (WANs), local area networks (LANs), wireless local area networks (WLANs), wired networks, wireless networks, metropolitan area networks, and other networks to enable communication between devices.

Network node QQ160 and wireless device QQ110 comprise various components described in more detail below. These components work together in order to provide network node and/or wireless device functionality, such as providing wireless connections in a wireless network. In different embodiments, the wireless network may comprise any number of wired or wireless networks, network nodes, base stations, controllers, wireless devices, relay stations, and/or any other components or systems that may facilitate or participate in the communication of data and/or signals whether via wired or wireless connections.

As used herein, network node refers to equipment capable, configured, arranged and/or operable to communicate directly or indirectly with a wireless device and/or with other network nodes or equipment in the wireless network to enable and/or provide wireless access to the wireless device and/or to perform other functions (e.g., administration) in the wireless network. Examples of network nodes include, but are not limited to, access points (APs) (e.g., radio access points), base stations (BSs) (e.g., radio base stations, Node Bs, evolved Node Bs (eNBs) and NR NodeBs (gNBs)). Base stations may be categorized based on the amount of coverage they provide (or, stated differently, their transmit power level) and may then also be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS). Yet further examples of network nodes include multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), core network nodes (e.g., MSCs, MMEs), O&M nodes, OSS nodes, SON nodes, positioning nodes (e.g., E-SMLCs), and/or MDTs. As another example, a network node may be a virtual network node as described in more detail below. More generally, however, network nodes may represent any suitable device (or group of devices) capable, configured, arranged, and/or operable to enable and/or provide a wireless device with access to the wireless network or to provide some service to a wireless device that has accessed the wireless network.

In FIG. QQ1, network node QQ160 includes processing circuitry QQ170, device readable medium QQ180, interface QQ190, auxiliary equipment QQ184, power source QQ186, power circuitry QQ187, and antenna QQ162. Although network node QQ160 illustrated in the example wireless network of FIG. QQ1 may represent a device that includes the illustrated combination of hardware components, other embodiments may comprise network nodes with different combinations of components. It is to be understood that a network node comprises any suitable combination of hardware and/or software needed to perform the tasks, features, functions, and methods disclosed herein. Moreover, while the components of network node QQ160 are depicted as single boxes located within a larger box, or nested within multiple boxes, in practice, a network node may comprise multiple different physical components that make up a single illustrated component (e.g., device readable medium QQ180 may comprise multiple separate hard drives as well as multiple RAM modules).

Similarly, network node QQ160 may be composed of multiple physically separate components (e.g., a NodeB component and a RNC component, or a BTS component and a BSC component, etc.), which may each have their own respective components. In certain scenarios in which network node QQ160 comprises multiple separate components (e.g., BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, network node QQ160 may be configured to support multiple radio access technologies (RATs). In such embodiments, some components may be duplicated (e.g., separate device readable medium QQ180 for the different RATs) and some components may be reused (e.g., the same antenna QQ162 may be shared by the RATs). Network node QQ160 may also include multiple sets of the various illustrated components for different wireless technologies integrated into network node QQ160, such as, for example, GSM, WCDMA, LTE, NR, Wi-Fi, or Bluetooth wireless technologies. These wireless technologies may be integrated into the same or different chip or set of chips and other components within network node QQ160.

Processing circuitry QQ170 is configured to perform any determining, calculating, or similar operations (e.g., certain obtaining operations) described herein as being provided by a network node. These operations performed by processing circuitry QQ170 may include processing information obtained by processing circuitry QQ170 by, for example, converting the obtained information into other information, comparing the obtained information, or converted information to information stored in the network node, and/or performing one or more operations based on the obtained information or converted information, and as a result of said processing making a determination.

Processing circuitry QQ170 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node QQ160 components, such as device readable medium QQ180, network node QQ160 functionality. For example, processing circuitry QQ170 may execute instructions stored in device readable medium QQ180 or in memory within processing circuitry QQ170. Such functionality may include providing any of the various wireless features, functions, or benefits discussed herein. In some embodiments, processing circuitry QQ170 may include a system on a chip (SOC).

In some embodiments, processing circuitry QQ170 may include one or more of radio frequency (RF) transceiver circuitry QQ172 and baseband processing circuitry QQ174. In some embodiments, radio frequency (RF) transceiver circuitry QQ172 and baseband processing circuitry QQ174 may be on separate chips (or sets of chips), boards, or units, such as radio units and digital units. In alternative embodiments, part, or all of RF transceiver circuitry QQ172 and baseband processing circuitry QQ174 may be on the same chip or set of chips, boards, or units In certain embodiments, some or all of the functionality described herein as being provided by a network node, base station, eNB or other such network device may be performed by processing circuitry QQ170 executing instructions stored on device readable medium QQ180 or memory within processing circuitry QQ170. In alternative embodiments, some or all of the functionality may be provided by processing circuitry QQ170 without executing instructions stored on a separate or discrete device readable medium, such as in a hard-wired manner. In any of those embodiments, whether executing instructions stored on a device readable storage medium or not, processing circuitry QQ170 can be configured to perform the described functionality. The benefits provided by such functionality are not limited to processing circuitry QQ170 alone or to other components of network node QQ160 but are enjoyed by network node QQ160 as a whole, and/or by end users and the wireless network generally.

Device readable medium QQ180 may comprise any form of volatile or non-volatile computer readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device readable and/or computer-executable memory devices that store information, data, and/or instructions that may be used by processing circuitry QQ170. Device readable medium QQ180 may store any suitable instructions, data or information, including a computer program, software, an application including one or more of logic, rules, code, tables, etc. and/or other instructions capable of being executed by processing circuitry QQ170 and, utilized by network node QQ160. Device readable medium QQ180 may be used to store any calculations made by processing circuitry QQ170 and/or any data received via interface QQ190. In some embodiments, processing circuitry QQ170 and device readable medium QQ180 may be considered to be integrated.

Interface QQ190 is used in the wired or wireless communication of signaling and/or data between network node QQ160, network QQ106, and/or wireless devices QQ110. As illustrated, interface QQ190 comprises port(s)/terminal(s) QQ194 to send and receive data, for example to and from network QQ106 over a wired connection. Interface QQ190 also includes radio front end circuitry QQ192 that may be coupled to, or in certain embodiments a part of, antenna QQ162. Radio front end circuitry QQ192 comprises filters QQ198 and amplifiers QQ196. Radio front end circuitry QQ192 may be connected to antenna QQ162 and processing circuitry QQ170. Radio front end circuitry may be configured to condition signals communicated between antenna QQ162 and processing circuitry QQ170. Radio front end circuitry QQ192 may receive digital data that is to be sent out to other network nodes or wireless devices via a wireless connection. Radio front end circuitry QQ192 may convert the digital data into a radio signal having the appropriate channel and bandwidth parameters using a combination of filters QQ198 and/or amplifiers QQ196. The radio signal may then be transmitted via antenna QQ162. Similarly, when receiving data, antenna QQ162 may collect radio signals which are then converted into digital data by radio front end circuitry QQ192. The digital data may be passed to processing circuitry QQ170. In other embodiments, the interface may comprise different components and/or different combinations of components.

In certain alternative embodiments, network node QQ160 may not include separate radio front end circuitry QQ192, instead, processing circuitry QQ170 may comprise radio front end circuitry and may be connected to antenna QQ162 without separate radio front end circuitry QQ192. Similarly, in some embodiments, all or some of RF transceiver circuitry QQ172 may be considered a part of interface QQ190. In still other embodiments, interface QQ190 may include one or more ports or terminals QQ194, radio front end circuitry QQ192, and RF transceiver circuitry QQ172, as part of a radio unit (not shown), and interface QQ190 may communicate with baseband processing circuitry QQ174, which is part of a digital unit (not shown).

Antenna QQ162 may include one or more antennas, or antenna arrays, configured to send and/or receive wireless signals. Antenna QQ162 may be coupled to radio front end circuitry QQ190 and may be any type of antenna capable of transmitting and receiving data and/or signals wirelessly. In some embodiments, antenna QQ162 may comprise one or more omni-directional, sector or panel antennas operable to transmit/receive radio signals between, for example, 2 GHz and 66 GHz. An omni-directional antenna may be used to transmit/receive radio signals in any direction, a sector antenna may be used to transmit/receive radio signals from devices within a particular area, and a panel antenna may be a line of sight antenna used to transmit/receive radio signals in a relatively straight line. In some instances, the use of more than one antenna may be referred to as MIMO. In certain embodiments, antenna QQ162 may be separate from network node QQ160 and may be connectable to network node QQ160 through an interface or port.

Antenna QQ162, interface QQ190, and/or processing circuitry QQ170 may be configured to perform any receiving operations and/or certain obtaining operations described herein as being performed by a network node. Any information, data and/or signals may be received from a wireless device, another network node and/or any other network equipment. Similarly, antenna QQ162, interface QQ190, and/or processing circuitry QQ170 may be configured to perform any transmitting operations described herein as being performed by a network node. Any information, data and/or signals may be transmitted to a wireless device, another network node and/or any other network equipment.

Power circuitry QQ187 may comprise, or be coupled to, power management circuitry and is configured to supply the components of network node QQ160 with power for performing the functionality described herein. Power circuitry QQ187 may receive power from power source QQ186. Power source QQ186 and/or power circuitry QQ187 may be configured to provide power to the various components of network node QQ160 in a form suitable for the respective components (e.g., at a voltage and current level needed for each respective component). Power source QQ186 may either be included in, or external to, power circuitry QQ187 and/or network node QQ160. For example, network node QQ160 may be connectable to an external power source (e.g., an electricity outlet) via an input circuitry or interface such as an electrical cable, whereby the external power source supplies power to power circuitry QQ187. As a further example, power source QQ186 may comprise a source of power in the form of a battery or battery pack which is connected to, or integrated in, power circuitry QQ187. The battery may provide backup power should the external power source fail. Other types of power sources, such as photovoltaic devices, may also be used.

Alternative embodiments of network node QQ160 may include additional components beyond those shown in FIG. QQ1 that may be responsible for providing certain aspects of the network node's functionality, including any of the functionality described herein and/or any functionality necessary to support the subject matter described herein. For example, network node QQ160 may include user interface equipment to allow input of information into network node QQ160 and to allow output of information from network node QQ160. This may allow a user to perform diagnostic, maintenance, repair, and other administrative functions for network node QQ160.

As used herein, wireless device refers to a device capable, configured, arranged and/or operable to communicate wirelessly with network nodes and/or other wireless devices. Unless otherwise noted, the term wireless device may be used interchangeably herein with user equipment (UE). Communicating wirelessly may involve transmitting and/or receiving wireless signals using electromagnetic waves, radio waves, infrared waves, and/or other types of signals suitable for conveying information through air. In some embodiments, a wireless device may be configured to transmit and/or receive information without direct human interaction. For instance, a wireless device may be designed to transmit information to a network on a predetermined schedule, when triggered by an internal or external event, or in response to requests from the network. Examples of a wireless device include, but are not limited to, a smart phone, a mobile phone, a cell phone, a voice over IP (VoIP) phone, a wireless local loop phone, a desktop computer, a personal digital assistant (PDA), a wireless cameras, a gaming console or device, a music storage device, a playback appliance, a wearable terminal device, a wireless endpoint, a mobile station, a tablet, a laptop, a laptop-embedded equipment (LEE), a laptop-mounted equipment (LME), a smart device, a wireless customer-premise equipment (CPE). a vehicle-mounted wireless terminal device, etc. A wireless device may support device-to-device (D2D) communication, for example by implementing a 3GPP standard for sidelink communication, vehicle-to-vehicle (V2V), vehicle-to-infrastructure (V2I), vehicle-to-everything (V2X) and may in this case be referred to as a D2D communication device. As yet another specific example, in an Internet of Things (IoT) scenario, a wireless device may represent a machine or other device that performs monitoring and/or measurements and transmits the results of such monitoring and/or measurements to another wireless device and/or a network node. The wireless device may in this case be a machine-to-machine (M2M) device, which may in a 3GPP context be referred to as an MTC device. As one particular example, the wireless device may be a UE implementing the 3GPP narrow band internet of things (NB-IoT) standard. Particular examples of such machines or devices are sensors, metering devices such as power meters, industrial machinery, or home or personal appliances (e.g., refrigerators, televisions, etc.) personal wearables (e.g., watches, fitness trackers, etc.). In other scenarios, a wireless device may represent a vehicle or other equipment that is capable of monitoring and/or reporting on its operational status or other functions associated with its operation. A wireless device as described above may represent the endpoint of a wireless connection, in which case the device may be referred to as a wireless terminal. Furthermore, a wireless device as described above may be mobile, in which case it may also be referred to as a mobile device or a mobile terminal.

As illustrated, wireless device QQ110 includes antenna QQ111, interface QQ114, processing circuitry QQ120, device readable medium QQ130, user interface equipment QQ132, auxiliary equipment QQ134, power source QQ136 and power circuitry QQ137. Wireless device QQ110 may include multiple sets of one or more of the illustrated components for different wireless technologies supported by wireless device QQ110, such as, for example, GSM, WCDMA, LTE, NR, Wi-Fi, WiMAX, NB-IoT, or Bluetooth wireless technologies, just to mention a few. These wireless technologies may be integrated into the same or different chips or set of chips as other components within wireless device QQ110.

Antenna QQ111 may include one or more antennas or antenna arrays, configured to send and/or receive wireless signals, and is connected to interface QQ114. In certain alternative embodiments, antenna QQ111 may be separate from wireless device QQ110 and be connectable to wireless device QQ110 through an interface or port. Antenna QQ111, interface QQ114, and/or processing circuitry QQ120 may be configured to perform any receiving or transmitting operations described herein as being performed by a wireless device. Any information, data and/or signals may be received from a network node and/or another wireless device. In some embodiments, radio front end circuitry and/or antenna QQ111 may be considered an interface.

As illustrated, interface QQ114 comprises radio front end circuitry QQ112 and antenna QQ111. Radio front end circuitry QQ112 comprise one or more filters QQ118 and amplifiers QQ116. Radio front end circuitry QQ114 is connected to antenna QQ111 and processing circuitry QQ120 and is configured to condition signals communicated between antenna QQ111 and processing circuitry QQ120. Radio front end circuitry QQ112 may be coupled to or a part of antenna QQ111. In some embodiments, wireless device QQ110 may not include separate radio front end circuitry QQ112; rather, processing circuitry QQ120 may comprise radio front end circuitry and may be connected to antenna QQ111. Similarly, in some embodiments, some or all of RF transceiver circuitry QQ122 may be considered a part of interface QQ114. Radio front end circuitry QQ112 may receive digital data that is to be sent out to other network nodes or wireless devices via a wireless connection. Radio front end circuitry QQ112 may convert the digital data into a radio signal having the appropriate channel and bandwidth parameters using a combination of filters QQ118 and/or amplifiers QQ116. The radio signal may then be transmitted via antenna QQ111. Similarly, when receiving data, antenna QQ111 may collect radio signals which are then converted into digital data by radio front end circuitry QQ112. The digital data may be passed to processing circuitry QQ120. In other embodiments, the interface may comprise different components and/or different combinations of components.

Processing circuitry QQ120 may comprise a combination of one or more of a microprocessor, controller, microcontroller, central processing unit, digital signal processor, application-specific integrated circuit, field programmable gate array, or any other suitable computing device, resource, or combination of hardware, software, and/or encoded logic operable to provide, either alone or in conjunction with other wireless device QQ110 components, such as device readable medium QQ130, wireless device QQ110 functionality. Such functionality may include providing any of the various wireless features or benefits discussed herein. For example, processing circuitry QQ120 may execute instructions stored in device readable medium QQ130 or in memory within processing circuitry QQ120 to provide the functionality disclosed herein.

As illustrated, processing circuitry QQ120 includes one or more of RF transceiver circuitry QQ122, baseband processing circuitry QQ124, and application processing circuitry QQ126. In other embodiments, the processing circuitry may comprise different components and/or different combinations of components. In certain embodiments processing circuitry QQ120 of wireless device QQ110 may comprise a SOC. In some embodiments, RF transceiver circuitry QQ122, baseband processing circuitry QQ124, and application processing circuitry QQ126 may be on separate chips or sets of chips. In alternative embodiments, part or all of baseband processing circuitry QQ124 and application processing circuitry QQ126 may be combined into one chip or set of chips, and RF transceiver circuitry QQ122 may be on a separate chip or set of chips. In still alternative embodiments, part or all of RF transceiver circuitry QQ122 and baseband processing circuitry QQ124 may be on the same chip or set of chips, and application processing circuitry QQ126 may be on a separate chip or set of chips. In yet other alternative embodiments, part or all of RF transceiver circuitry QQ122, baseband processing circuitry QQ124, and application processing circuitry QQ126 may be combined in the same chip or set of chips. In some embodiments, RF transceiver circuitry QQ122 may be a part of interface QQ114. RF transceiver circuitry QQ122 may condition RF signals for processing circuitry QQ120.

In certain embodiments, some or all of the functionality described herein as being performed by a wireless device may be provided by processing circuitry QQ120 executing instructions stored on device readable medium QQ130, which in certain embodiments may be a computer-readable storage medium. In alternative embodiments, some or all of the functionality may be provided by processing circuitry QQ120 without executing instructions stored on a separate or discrete device readable storage medium, such as in a hard-wired manner. In any of those particular embodiments, whether executing instructions stored on a device readable storage medium or not, processing circuitry QQ120 can be configured to perform the described functionality. The benefits provided by such functionality are not limited to processing circuitry QQ120 alone or to other components of wireless device QQ110 but are enjoyed by wireless device QQ110 as a whole, and/or by end users and the wireless network generally.

Processing circuitry QQ120 may be configured to perform any determining, calculating, or similar operations (e.g., certain obtaining operations) described herein as being performed by a wireless device. These operations, as performed by processing circuitry QQ120, may include processing information obtained by processing circuitry QQ120 by, for example, converting the obtained information into other information, comparing the obtained information, or converted information to information stored by wireless device QQ110, and/or performing one or more operations based on the obtained information or converted information, and as a result of said processing making a determination.

Device readable medium QQ130 may be operable to store a computer program, software, an application including one or more of logic, rules, code, tables, etc. and/or other instructions capable of being executed by processing circuitry QQ120. Device readable medium QQ130 may include computer memory (e.g., Random Access Memory (RAM) or Read Only Memory (ROM)), mass storage media (e.g., a hard disk), removable storage media (e.g., a Compact Disk (CD) or a Digital Video Disk (DVD)), and/or any other volatile or non-volatile, non-transitory device readable and/or computer executable memory devices that store information, data, and/or instructions that may be used by processing circuitry QQ120. In some embodiments, processing circuitry QQ120 and device readable medium QQ130 may be considered to be integrated.

User interface equipment QQ132 may provide components that allow for a human user to interact with wireless device QQ110. Such interaction may be of many forms, such as visual, audial, tactile, etc. User interface equipment QQ132 may be operable to produce output to the user and to allow the user to provide input to wireless device QQ110. The type of interaction may vary depending on the type of user interface equipment QQ132 installed in wireless device QQ110. For example, if wireless device QQ110 is a smart phone, the interaction may be via a touch screen; if wireless device QQ110 is a smart meter, the interaction may be through a screen that provides usage (e.g., the number of gallons used) or a speaker that provides an audible alert (e.g., if smoke is detected). User interface equipment QQ132 may include input interfaces, devices and circuits, and output interfaces, devices, and circuits. User interface equipment QQ132 is configured to allow input of information into wireless device QQ110 and is connected to processing circuitry QQ120 to allow processing circuitry QQ120 to process the input information. User interface equipment QQ132 may include, for example, a microphone, a proximity or other sensor, keys/buttons, a touch display, one or more cameras, a USB port, or other input circuitry. User interface equipment QQ132 is also configured to allow output of information from wireless device QQ110, and to allow processing circuitry QQ120 to output information from wireless device QQ110. User interface equipment QQ132 may include, for example, a speaker, a display, vibrating circuitry, a USB port, a headphone interface, or other output circuitry. Using one or more input and output interfaces, devices, and circuits, of user interface equipment QQ132, wireless device QQ110 may communicate with end users and/or the wireless network and allow them to benefit from the functionality described herein.

Auxiliary equipment QQ134 is operable to provide more specific functionality which may not be generally performed by wireless devices. This may comprise specialized sensors for doing measurements for various purposes, interfaces for additional types of communication such as wired communications etc. The inclusion and type of components of auxiliary equipment QQ134 may vary depending on the embodiment and/or scenario.

Power source QQ136 may, in some embodiments, be in the form of a battery or battery pack. Other types of power sources, such as an external power source (e.g., an electricity outlet), photovoltaic devices or power cells, may also be used. Wireless device QQ110 may further comprise power circuitry QQ137 for delivering power from power source QQ136 to the various parts of wireless device QQ110 which need power from power source QQ136 to carry out any functionality described or indicated herein. Power circuitry QQ137 may in certain embodiments comprise power management circuitry. Power circuitry QQ137 may additionally or alternatively be operable to receive power from an external power source; in which case wireless device QQ110 may be connectable to the external power source (such as an electricity outlet) via input circuitry or an interface such as an electrical power cable. Power circuitry QQ137 may also in certain embodiments be operable to deliver power from an external power source to power source QQ136. This may be, for example, for the charging of power source QQ136. Power circuitry QQ137 may perform any formatting, converting, or other modification to the power from power source QQ136 to make the power suitable for the respective components of wireless device QQ110 to which power is supplied.

FIG. QQ2 illustrates one embodiment of a UE in accordance with various aspects described herein. As used herein, a user equipment or UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter). UE QQ2200 may be any UE identified by the 3rd Generation Partnership Project (3GPP), including a NB-IoT UE, a machine type communication (MTC) UE, and/or an enhanced MTC (eMTC) UE. UE QQ200, as illustrated in FIG. QQ2, is one example of a wireless device configured for communication in accordance with one or more communication standards promulgated by the 3rd Generation Partnership Project (3GPP), such as 3GPP's GSM, UMTS, LTE, and/or 5G standards. As mentioned previously, the term wireless device and UE may be used interchangeable. Accordingly, although FIG. QQ2 is a UE, the components discussed herein are equally applicable to a wireless device, and vice-versa.

In FIG. QQ2, UE QQ200 includes processing circuitry QQ201 that is operatively coupled to input/output interface QQ205, radio frequency (RF) interface QQ209, network connection interface QQ211, memory QQ215 including random access memory (RAM) QQ217, read-only memory (ROM) QQ219, and storage medium QQ221 or the like, communication subsystem QQ231, power source QQ233, and/or any other component, or any combination thereof. Storage medium QQ221 includes operating system QQ223, application program QQ225, and data QQ227. In other embodiments, storage medium QQ221 may include other similar types of information. Certain UEs may utilize all of the components shown in Figure QQ2, or only a subset of the components. The level of integration between the components may vary from one UE to another UE. Further, certain UEs may contain multiple instances of a component, such as multiple processors, memories, transceivers, transmitters, receivers, etc.

In FIG. QQ2, processing circuitry QQ201 may be configured to process computer instructions and data. Processing circuitry QQ201 may be configured to implement any sequential state machine operative to execute machine instructions stored as machine-readable computer programs in the memory, such as one or more hardware-implemented state machines (e.g., in discrete logic, FPGA, ASIC, etc.); programmable logic together with appropriate firmware; one or more stored program, general-purpose processors, such as a microprocessor or Digital Signal Processor (DSP), together with appropriate software; or any combination of the above. For example, the processing circuitry QQ201 may include two central processing units (CPUs). Data may be information in a form suitable for use by a computer.

In the depicted embodiment, input/output interface QQ205 may be configured to provide a communication interface to an input device, output device, or input and output device. UE QQ200 may be configured to use an output device via input/output interface QQ205. An output device may use the same type of interface port as an input device. For example, a USB port may be used to provide input to and output from UE QQ200. The output device may be a speaker, a sound card, a video card, a display, a monitor, a printer, an actuator, an emitter, a smartcard, another output device, or any combination thereof. UE QQ200 may be configured to use an input device via input/output interface QQ205 to allow a user to capture information into UE QQ200. The input device may include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, another like sensor, or any combination thereof. For example, the input device may be an accelerometer, a magnetometer, a digital camera, a microphone, and an optical sensor.

In FIG. QQ2, RF interface QQ209 may be configured to provide a communication interface to RF components such as a transmitter, a receiver, and an antenna. Network connection interface QQ211 may be configured to provide a communication interface to network QQ243a. Network QQ243a may encompass wired and/or wireless networks such as a local-area network (LAN), a wide-area network (WAN), a computer network, a wireless network, a telecommunications network, another like network or any combination thereof. For example, network QQ243a may comprise a Wi-Fi network. Network connection interface QQ211 may be configured to include a receiver and a transmitter interface used to communicate with one or more other devices over a communication network according to one or more communication protocols, such as Ethernet, TCP/IP, SONET, ATM, or the like. Network connection interface QQ211 may implement receiver and transmitter functionality appropriate to the communication network links (e.g., optical, electrical, and the like). The transmitter and receiver functions may share circuit components, software, or firmware, or alternatively may be implemented separately.

RAM QQ217 may be configured to interface via bus QQ202 to processing circuitry QQ201 to provide storage or caching of data or computer instructions during the execution of software programs such as the operating system, application programs, and device drivers. ROM QQ219 may be configured to provide computer instructions or data to processing circuitry QQ201. For example, ROM QQ219 may be configured to store invariant low-level system code or data for basic system functions such as basic input and output (I/O), startup, or reception of keystrokes from a keyboard that are stored in a non-volatile memory. Storage medium QQ221 may be configured to include memory such as RAM, ROM, programmable read-only memory (PROM), erasable programmable read-only memory (EPROM), electrically erasable programmable read-only memory (EEPROM), magnetic disks, optical disks, floppy disks, hard disks, removable cartridges, or flash drives. In one example, storage medium QQ221 may be configured to include operating system QQ223, application program QQ225 such as a web browser application, a widget or gadget engine or another application, and data file QQ227. Storage medium QQ221 may store, for use by UE QQ200, any of a variety of various operating systems or combinations of operating systems.

Storage medium QQ221 may be configured to include a number of physical drive units, such as redundant array of independent disks (RAID), floppy disk drive, flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as a subscriber identity module or a removable user identity (SIM/RUIM) module, other memory, or any combination thereof. Storage medium QQ221 may allow UE QQ200 to access computer-executable instructions, application programs or the like, stored on transitory or non-transitory memory media, to off-load data, or to upload data. An article of manufacture, such as one utilizing a communication system may be tangibly embodied in storage medium QQ221, which may comprise a device readable medium.

In FIG. QQ2, processing circuitry QQ201 may be configured to communicate with network QQ243b using communication subsystem QQ231. Network QQ243a and network QQ243b may be the same network or networks or different network or networks.

Communication subsystem QQ231 may be configured to include one or more transceivers used to communicate with network QQ243b. For example, communication subsystem QQ231 may be configured to include one or more transceivers used to communicate with one or more remote transceivers of another device capable of wireless communication such as another wireless device, UE, or base station of a radio access network (RAN) according to one or more communication protocols, such as IEEE 802.11, CDMA, WCDMA, GSM, LTE, UTRAN, WiMAX, or the like. Each transceiver may include transmitter QQ233 and/or receiver QQ235 to implement transmitter or receiver functionality, respectively, appropriate to the RAN links (e.g., frequency allocations and the like). Further, transmitter QQ233 and receiver QQ235 of each transceiver may share circuit components, software, or firmware, or alternatively may be implemented separately.

In the illustrated embodiment, the communication functions of communication subsystem QQ231 may include data communication, voice communication, multimedia communication, short-range communications such as Bluetooth, near-field communication, location-based communication such as the use of the global positioning system (GPS) to determine a location, another like communication function, or any combination thereof. For example, communication subsystem QQ231 may include cellular communication, Wi-Fi communication, Bluetooth communication, and GPS communication. Network QQ243b may encompass wired and/or wireless networks such as a local-area network (LAN), a wide-area network (WAN), a computer network, a wireless network, a telecommunications network, another like network or any combination thereof. For example, network QQ243b may be a cellular network, a Wi-Fi network, and/or a near-field network. Power source QQ213 may be configured to provide alternating current (AC) or direct current (DC) power to components of UE QQ200.

The features, benefits and/or functions described herein may be implemented in one of the components of UE QQ200 or partitioned across multiple components of UE QQ200. Further, the features, benefits, and/or functions described herein may be implemented in any combination of hardware, software, or firmware. In one example, communication subsystem QQ231 may be configured to include any of the components described herein. Further, processing circuitry QQ201 may be configured to communicate with any of such components over bus QQ202. In another example, any of such components may be represented by program instructions stored in memory that when executed by processing circuitry QQ201 perform the corresponding functions described herein. In another example, the functionality of any of such components may be partitioned between processing circuitry QQ201 and communication subsystem QQ231. In another example, the non-computationally intensive functions of any of such components may be implemented in software or firmware and the computationally intensive functions may be implemented in hardware.

FIG. QQ3 is a schematic block diagram illustrating a virtualization environment QQ300 in which functions implemented by some embodiments may be virtualized. In the present context, virtualizing means creating virtual versions of apparatuses or devices which may include virtualizing hardware platforms, storage devices and networking resources. As used herein, virtualization can be applied to a node (e.g., a virtualized base station or a virtualized radio access node) or to a device (e.g., a UE, a wireless device or any other type of communication device) or components thereof and relates to an implementation in which at least a portion of the functionality is implemented as one or more virtual components (e.g., via one or more applications, components, functions, virtual machines or containers executing on one or more physical processing nodes in one or more networks).

In some embodiments, some or all of the functions described herein may be implemented as virtual components executed by one or more virtual machines implemented in one or more virtual environments QQ300 hosted by one or more of hardware nodes QQ330. Further, in embodiments in which the virtual node is not a radio access node or does not require radio connectivity (e.g., a core network node), then the network node may be entirely virtualized.

The functions may be implemented by one or more applications QQ320 (which may alternatively be called software instances, virtual appliances, network functions, virtual nodes, virtual network functions, etc.) operative to implement some of the features, functions, and/or benefits of some of the embodiments disclosed herein. Applications QQ320 are run in virtualization environment QQ300 which provides hardware QQ330 comprising processing circuitry QQ360 and memory QQ390. Memory QQ390 contains instructions QQ395 executable by processing circuitry QQ360 whereby application QQ320 is operative to provide one or more of the features, benefits, and/or functions disclosed herein.

Virtualization environment QQ300, comprises general-purpose or special-purpose network hardware devices QQ330 comprising a set of one or more processors or processing circuitry QQ360, which may be commercial off-the-shelf (COTS) processors, dedicated Application Specific Integrated Circuits (ASICs), or any other type of processing circuitry including digital or analog hardware components or special purpose processors. Each hardware device may comprise memory QQ390-1 which may be non-persistent memory for temporarily storing instructions QQ395 or software executed by processing circuitry QQ360. Each hardware device may comprise one or more network interface controllers (NICs) QQ370, also known as network interface cards, which include physical network interface QQ380. Each hardware device may also include non-transitory, persistent, machine-readable storage media QQ390-2 having stored therein software QQ395 and/or instructions executable by processing circuitry QQ360. Software QQ395 may include any type of software including software for instantiating one or more virtualization layers QQ350 (also referred to as hypervisors), software to execute virtual machines QQ340 as well as software allowing it to execute functions, features and/or benefits described in relation with some embodiments described herein.

Virtual machines QQ340, comprise virtual processing, virtual memory, virtual networking or interface and virtual storage, and may be run by a corresponding virtualization layer QQ350 or hypervisor. Different embodiments of the instance of virtual appliance QQ320 may be implemented on one or more of virtual machines QQ340, and the implementations may be made in different ways.

During operation, processing circuitry QQ360 executes software QQ395 to instantiate the hypervisor or virtualization layer QQ350, which may sometimes be referred to as a virtual machine monitor (VMM). Virtualization layer QQ350 may present a virtual operating platform that appears like networking hardware to virtual machine QQ340.

As shown in FIG. QQ3, hardware QQ330 may be a standalone network node with generic or specific components. Hardware QQ330 may comprise antenna QQ3225 and may implement some functions via virtualization. Alternatively, hardware QQ330 may be part of a larger cluster of hardware (e.g., such as in a data center or customer premise equipment (CPE)) where many hardware nodes work together and are managed via management and orchestration (MANO) QQ3100, which, among others, oversees lifecycle management of applications QQ320.

Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, virtual machine QQ340 may be a software implementation of a physical machine that runs programs as if they were executing on a physical, non-virtualized machine. Each of virtual machines QQ340, and that part of hardware QQ330 that executes that virtual machine, be it hardware dedicated to that virtual machine and/or hardware shared by that virtual machine with others of the virtual machines QQ340, forms a separate virtual network elements (VNE).

Still in the context of NFV, Virtual Network Function (VNF) is responsible for handling specific network functions that run in one or more virtual machines QQ340 on top of hardware networking infrastructure QQ330 and corresponds to application QQ320 in FIG. QQ3.

In some embodiments, one or more radio units QQ3200 that each include one or more transmitters QQ3220 and one or more receivers QQ3210 may be coupled to one or more antennas QQ3225. Radio units QQ3200 may communicate directly with hardware nodes QQ330 via one or more appropriate network interfaces and may be used in combination with the virtual components to provide a virtual node with radio capabilities, such as a radio access node or a base station.

In some embodiments, some signaling can be effected with the use of control system QQ3230 which may alternatively be used for communication between the hardware nodes QQ330 and radio units QQ3200.

FIG. QQ4 illustrates a telecommunication network connected via an intermediate network to a host computer in accordance with some embodiments. In particular, with reference to FIGURE QQ4, in accordance with an embodiment, a communication system includes telecommunication network QQ410, such as a 3GPP-type cellular network, which comprises access network QQ411, such as a radio access network, and core network QQ414. Access network QQ411 comprises a plurality of base stations QQ412a, QQ412b, QQ412c, such as NBs, eNBs, gNBs or other types of wireless access points, each defining a corresponding coverage area QQ413a, QQ413b, QQ413c. Each base station QQ412a, QQ412b, QQ412c is connectable to core network QQ414 over a wired or wireless connection QQ415. A first UE QQ491 located in coverage area QQ413c is configured to wirelessly connect to, or be paged by, the corresponding base station QQ412c. A second UE QQ492 in coverage area QQ413a is wirelessly connectable to the corresponding base station QQ412a. While a plurality of UEs QQ491, QQ492 are illustrated in this example, the disclosed embodiments are equally applicable to a situation where a sole UE is in the coverage area or where a sole UE is connecting to the corresponding base station QQ412.

Telecommunication network QQ410 is itself connected to host computer QQ430, which may be embodied in the hardware and/or software of a standalone server, a cloud-implemented server, a distributed server or as processing resources in a server farm. Host computer QQ430 may be under the ownership or control of a service provider or may be operated by the service provider or on behalf of the service provider. Connections QQ421 and QQ422 between telecommunication network QQ410 and host computer QQ430 may extend directly from core network QQ414 to host computer QQ430 or may go via an optional intermediate network QQ420. Intermediate network QQ420 may be one of, or a combination of more than one of, a public, private or hosted network; intermediate network QQ420, if any, may be a backbone network or the Internet; in particular, intermediate network QQ420 may comprise two or more sub-networks (not shown).

The communication system of FIG. QQ4 as a whole enables connectivity between the connected UEs QQ491, QQ492 and host computer QQ430. The connectivity may be described as an over-the-top (OTT) connection QQ450. Host computer QQ430 and the connected UEs QQ491, QQ492 are configured to communicate data and/or signaling via OTT connection QQ450, using access network QQ411, core network QQ414, any intermediate network QQ420 and possible further infrastructure (not shown) as intermediaries. OTT connection QQ450 may be transparent in the sense that the participating communication devices through which OTT connection QQ450 passes are unaware of routing of uplink and downlink communications. For example, base station QQ412 may not or need not be informed about the past routing of an incoming downlink communication with data originating from host computer QQ430 to be forwarded (e.g., handed over) to a connected UE QQ491. Similarly, base station QQ412 need not be aware of the future routing of an outgoing uplink communication originating from the UE QQ491 towards the host computer QQ430.

Example implementations, in accordance with an embodiment, of the UE, base station and host computer discussed in the preceding paragraphs will now be described with reference to FIG. QQ5. FIG. QQ5 illustrates host computer communicating via a base station with a user equipment over a partially wireless connection in accordance with some embodiments. In communication system QQ500, host computer QQ510 comprises hardware QQ515 including communication interface QQ516 configured to set up and maintain a wired or wireless connection with an interface of a different communication device of communication system QQ500. Host computer QQ510 further comprises processing circuitry QQ518, which may have storage and/or processing capabilities. In particular, processing circuitry QQ518 may comprise one or more programmable processors, application-specific integrated circuits, field programmable gate arrays or combinations of these (not shown) adapted to execute instructions. Host computer QQ510 further comprises software QQ511, which is stored in or accessible by host computer QQ510 and executable by processing circuitry QQ518. Software QQ511 includes host application QQ512. Host application QQ512 may be operable to provide a service to a remote user, such as UE QQ530 connecting via OTT connection QQ550 terminating at UE QQ530 and host computer QQ510. In providing the service to the remote user, host application QQ512 may provide user data which is transmitted using OTT connection QQ550.

Communication system QQ500 further includes base station QQ520 provided in a telecommunication system and comprising hardware QQ525 enabling it to communicate with host computer QQ510 and with UE QQ530. Hardware QQ525 may include communication interface QQ526 for setting up and maintaining a wired or wireless connection with an interface of a different communication device of communication system QQ500, as well as radio interface QQ527 for setting up and maintaining at least wireless connection QQ570 with UE QQ530 located in a coverage area (not shown in FIG. QQ5) served by base station QQ520. Communication interface QQ526 may be configured to facilitate connection QQ560 to host computer QQ510. Connection QQ560 may be direct, or it may pass through a core network (not shown in FIG. QQ5) of the telecommunication system and/or through one or more intermediate networks outside the telecommunication system. In the embodiment shown, hardware QQ525 of base station QQ520 further includes processing circuitry QQ528, which may comprise one or more programmable processors, application-specific integrated circuits, field programmable gate arrays or combinations of these (not shown) adapted to execute instructions. Base station QQ520 further has software QQ521 stored internally or accessible via an external connection.

Communication system QQ500 further includes UE QQ530 already referred to. UE hardware QQ535 may include radio interface QQ537 configured to set up and maintain wireless connection QQ570 with a base station serving a coverage area in which UE QQ530 is currently located. Hardware QQ535 of UE QQ530 further includes processing circuitry QQ538, which may comprise one or more programmable processors, application-specific integrated circuits, field programmable gate arrays or combinations of these (not shown) adapted to execute instructions. UE QQ530 further comprises software QQ531, which is stored in or accessible by UE QQ530 and executable by processing circuitry QQ538. Software QQ531 includes client application QQ532. Client application QQ532 may be operable to provide a service to a human or non-human user via UE QQ530, with the support of host computer QQ510. In host computer QQ510, an executing host application QQ512 may communicate with the executing client application QQ532 via OTT connection QQ550 terminating at UE QQ530 and host computer QQ510. In providing the service to the user, client application QQ532 may receive request data from host application QQ512 and provide user data in response to the request data. OTT connection QQ550 may transfer both the request data and the user data. Client application QQ532 may interact with the user to generate the user data that it provides.

It is noted that host computer QQ510, base station QQ520 and UE QQ530 illustrated in FIG. QQ5 may be similar or identical to host computer QQ430, one of base stations QQ412a, QQ412b, QQ412c and one of UEs QQ491, QQ492 of FIG. QQ4, respectively. This is to say, the inner workings of these entities may be as shown in FIG. QQ5 and independently, the surrounding network topology may be that of FIG. QQ4.

In FIG. QQ5, OTT connection QQ550 has been drawn abstractly to illustrate the communication between host computer QQ510 and UE QQ530 via base station QQ520, without explicit reference to any intermediary devices and the precise routing of messages via these devices. Network infrastructure may determine the routing, which it may be configured to hide from UE QQ530 or from the service provider operating host computer QQ510, or both. While OTT connection QQ550 is active, the network infrastructure may further take decisions by which it dynamically changes the routing (e.g., on the basis of load balancing consideration or reconfiguration of the network).

Wireless connection QQ570 between UE QQ530 and base station QQ520 is in accordance with the teachings of the embodiments described throughout this disclosure. One or more of the various embodiments improve the performance of OTT services provided to UE QQ530 using OTT connection QQ550, in which wireless connection QQ570 forms the last segment.

A measurement procedure may be provided for the purpose of monitoring data rate, latency, and other factors on which the one or more embodiments improve. There may further be an optional network functionality for reconfiguring OTT connection QQ550 between host computer QQ510 and UE QQ530, in response to variations in the measurement results. The measurement procedure and/or the network functionality for reconfiguring OTT connection QQ550 may be implemented in software QQ511 and hardware QQ515 of host computer QQ510 or in software QQ531 and hardware QQ535 of UE QQ530, or both. In embodiments, sensors (not shown) may be deployed in or in association with communication devices through which OTT connection QQ550 passes; the sensors may participate in the measurement procedure by supplying values of the monitored quantities exemplified above or supplying values of other physical quantities from which software QQ511, QQ531 may compute or estimate the monitored quantities. The reconfiguring of OTT connection QQ550 may include message format, retransmission settings, preferred routing etc.; the reconfiguring need not affect base station QQ520, and it may be unknown or imperceptible to base station QQ520. Such procedures and functionalities may be known and practiced in the art. In certain embodiments, measurements may involve proprietary UE signaling facilitating host computer QQ510's measurements of throughput, propagation times, latency and the like. The measurements may be implemented in that software QQ511 and QQ531 causes messages to be transmitted, in particular empty or ‘dummy’ messages, using OTT connection QQ550 while it monitors propagation times, errors etc.

FIG. QQ6 is a flowchart illustrating a method implemented in a communication system, in accordance with one embodiment. The communication system includes a host computer, a base station and a UE which may be those described with reference to Figures QQ4 and QQ5. For simplicity of the present disclosure, only drawing references to FIG. QQ6 will be included in this section. In step QQ610, the host computer provides user data. In sub-step QQ611 (which may be optional) of step QQ610, the host computer provides the user data by executing a host application. In step QQ620, the host computer initiates a transmission carrying the user data to the UE. In step QQ630 (which may be optional), the base station transmits to the UE the user data which was carried in the transmission that the host computer initiated, in accordance with the teachings of the embodiments described throughout this disclosure. In step QQ640 (which may also be optional), the UE executes a client application associated with the host application executed by the host computer.

FIG. QQ7 is a flowchart illustrating a method implemented in a communication system, in accordance with one embodiment. The communication system includes a host computer, a base station and a UE which may be those described with reference to Figures QQ4 and QQ5. For simplicity of the present disclosure, only drawing references to FIG. QQ7 will be included in this section. In step QQ710 of the method, the host computer provides user data. In an optional sub-step (not shown) the host computer provides the user data by executing a host application. In step QQ720, the host computer initiates a transmission carrying the user data to the UE. The transmission may pass via the base station, in accordance with the teachings of the embodiments described throughout this disclosure. In step QQ730 (which may be optional), the UE receives the user data carried in the transmission.

FIG. QQ8 is a flowchart illustrating a method implemented in a communication system, in accordance with one embodiment. The communication system includes a host computer, a base station and a UE which may be those described with reference to Figures QQ4 and QQ5. For simplicity of the present disclosure, only drawing references to FIG. QQ8 will be included in this section. In step QQ810 (which may be optional), the UE receives input data provided by the host computer. Additionally, or alternatively, in step QQ820, the UE provides user data. In sub-step QQ821 (which may be optional) of step QQ820, the UE provides the user data by executing a client application. In sub-step QQ811 (which may be optional) of step QQ810, the UE executes a client application which provides the user data in reaction to the received input data provided by the host computer. In providing the user data, the executed client application may further consider user input received from the user. Regardless of the specific manner in which the user data was provided, the UE initiates, in sub-step QQ830 (which may be optional), transmission of the user data to the host computer. In step QQ840 of the method, the host computer receives the user data transmitted from the UE, in accordance with the teachings of the embodiments described throughout this disclosure.

FIG. QQ9 is a flowchart illustrating a method implemented in a communication system, in accordance with one embodiment. The communication system includes a host computer, a base station and a UE which may be those described with reference to Figures QQ4 and QQ5. For simplicity of the present disclosure, only drawing references to FIG. QQ9 will be included in this section. In step QQ910 (which may be optional), in accordance with the teachings of the embodiments described throughout this disclosure, the base station receives user data from the UE. In step QQ920 (which may be optional), the base station initiates transmission of the received user data to the host computer. In step QQ930 (which may be optional), the host computer receives the user data carried in the transmission initiated by the base station.

FIGS. VV1 and VV2 depict a virtual wireless device VV100 and a virtual network node VV200, respectively.

The virtual wireless device VV100 is realized, for example, in a virtualization environment executing on underlying physical processing circuitry and it comprises one or more processing units VV102 and one or more transmission/reception units VV104. The virtual wireless device VV100 operates, for example, in the manner described above for a UE or other wireless communication device 12.

The virtual network node VV200 is realized, for example, in a virtualization environment executing on underlying physical processing circuitry and it comprises one or more processing units VV202 and one or more transmission/reception units VV204. The network node VV200 operates, for example, in the manner described above for a network node 24 as described herein.

Any appropriate steps, methods, features, functions, or benefits disclosed herein may be performed through one or more functional units or modules of one or more virtual apparatuses. Each virtual apparatus may comprise a number of these functional units. These functional units may be implemented via processing circuitry, which may include one or more microprocessor or microcontrollers, as well as other digital hardware, which may include digital signal processors (DSPs), special-purpose digital logic, and the like. The processing circuitry may be configured to execute program code stored in memory, which may include one or several types of memory such as read-only memory (ROM), random-access memory (RAM), cache memory, flash memory devices, optical storage devices, etc. Program code stored in memory includes program instructions for executing one or more telecommunications and/or data communications protocols as well as instructions for carrying out one or more of the techniques described herein. In some implementations, the processing circuitry may be used to cause the respective functional unit to perform corresponding functions according one or more embodiments of the present disclosure.

In view of the above, then, embodiments herein generally include a communication system including a host computer. The host computer may comprise processing circuitry configured to provide user data. The host computer may also comprise a communication interface configured to forward the user data to a cellular network for transmission to a user equipment (UE). The cellular network may comprise a base station having a radio interface and processing circuitry, the base station's processing circuitry configured to perform any of the steps of any of the embodiments described above for a base station.

In some embodiments, the communication system further includes the base station.

In some embodiments, the communication system further includes the UE, wherein the UE is configured to communicate with the base station.

In some embodiments, the processing circuitry of the host computer is configured to execute a host application, thereby providing the user data. In this case, the UE comprises processing circuitry configured to execute a client application associated with the host application.

Embodiments herein also include a method implemented in a communication system including a host computer, a base station and a user equipment (UE). The method comprises, at the host computer, providing user data. The method may also comprise, at the host computer, initiating a transmission carrying the user data to the UE via a cellular network comprising the base station. The base station performs any of the steps of any of the embodiments described above for a base station.

In some embodiments, the method further comprising, at the base station, transmitting the user data.

In some embodiments, the user data is provided at the host computer by executing a host application. In this case, the method further comprises, at the UE, executing a client application associated with the host application.

Embodiments herein also include a user equipment (UE) configured to communicate with a base station. The UE comprises a radio interface and processing circuitry configured to perform any of the embodiments above described for a UE.

Embodiments herein further include a communication system including a host computer. The host computer comprises processing circuitry configured to provide user data, and a communication interface configured to forward user data to a cellular network for transmission to a user equipment (UE). The UE comprises a radio interface and processing circuitry. The UE's components are configured to perform any of the steps of any of the embodiments described above for a UE.

In some embodiments, the cellular network further includes a base station configured to communicate with the UE.

In some embodiments, the processing circuitry of the host computer is configured to execute a host application, thereby providing the user data. The UE's processing circuitry is configured to execute a client application associated with the host application.

Embodiments also include a method implemented in a communication system including a host computer, a base station and a user equipment (UE). The method comprises, at the host computer, providing user data and initiating a transmission carrying the user data to the UE via a cellular network comprising the base station. The UE performs any of the steps of any of the embodiments described above for a UE.

In some embodiments, the method further comprises, at the UE, receiving the user data from the base station.

Embodiments herein further include a communication system including a host computer. The host computer comprises a communication interface configured to receive user data originating from a transmission from a user equipment (UE) to a base station. The UE comprises a radio interface and processing circuitry. The UE's processing circuitry is configured to perform any of the steps of any of the embodiments described above for a UE.

In some embodiments the communication system further includes the UE.

In some embodiments, the communication system further including the base station. In this case, the base station comprises a radio interface configured to communicate with the UE and a communication interface configured to forward to the host computer the user data carried by a transmission from the UE to the base station.

In some embodiments, the processing circuitry of the host computer is configured to execute a host application. And the UE's processing circuitry is configured to execute a client application associated with the host application, thereby providing the user data.

In some embodiments, the processing circuitry of the host computer is configured to execute a host application, thereby providing request data. And the UE's processing circuitry is configured to execute a client application associated with the host application, thereby providing the user data in response to the request data.

Embodiments herein also include a method implemented in a communication system including a host computer, a base station and a user equipment (UE). The method comprises, at the host computer, receiving user data transmitted to the base station from the UE. The UE performs any of the steps of any of the embodiments described above for the UE.

In some embodiments, the method further comprises, at the UE, providing the user data to the base station.

In some embodiments, the method also comprises, at the UE, executing a client application, thereby providing the user data to be transmitted. The method may further comprise, at the host computer, executing a host application associated with the client application.

In some embodiments, the method further comprises, at the UE, executing a client application, and, at the UE, receiving input data to the client application. The input data is provided at the host computer by executing a host application associated with the client application. The user data to be transmitted is provided by the client application in response to the input data.

Embodiments also include a communication system including a host computer. The host computer comprises a communication interface configured to receive user data originating from a transmission from a user equipment (UE) to a base station. The base station comprises a radio interface and processing circuitry. The base station's processing circuitry is configured to perform any of the steps of any of the embodiments described above for a base station.

In some embodiments, the communication system further includes the base station.

In some embodiments, the communication system further includes the UE. The UE is configured to communicate with the base station.

In some embodiments, the processing circuitry of the host computer is configured to execute a host application. And the UE is configured to execute a client application associated with the host application, thereby providing the user data to be received by the host computer.

Embodiments moreover include a method implemented in a communication system including a host computer, a base station and a user equipment (UE). The method comprises, at the host computer, receiving, from the base station, user data originating from a transmission which the base station has received from the UE. The UE performs any of the steps of any of the embodiments described above for a UE.

In some embodiments, the method further comprises, at the base station, receiving the user data from the UE.

In some embodiments, the method further comprises, at the base station, initiating a transmission of the received user data to the host computer.

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step. Any feature of any of the embodiments disclosed herein may be applied to any other embodiment, wherever appropriate. Likewise, any advantage of any of the embodiments may apply to any other embodiments, and vice versa. Other objectives, features, and advantages of the enclosed embodiments will be apparent from the description.

The term unit may have conventional meaning in the field of electronics, electrical devices and/or electronic devices and may include, for example, electrical and/or electronic circuitry, devices, modules, processors, memories, logic solid state and/or discrete devices, computer programs or instructions for carrying out respective tasks, procedures, computations, outputs, and/or displaying functions, and so on, as such as those that are described herein.

The term “A and/or B” as used herein covers embodiments having A alone, B alone, or both A and B together. The term “A and/or B” may therefore equivalently mean “at least one of any one or more of A and B”.

Some of the embodiments contemplated herein are described more fully with reference to the accompanying drawings. Other embodiments, however, are contained within the scope of the subject matter disclosed herein. The disclosed subject matter should not be construed as limited to only the embodiments set forth herein; rather, these embodiments are provided by way of example to convey the scope of the subject matter to those skilled in the art.

1-26. (canceled)

27. A method performed by a network node included in or communicatively coupled to a wireless communication network, the method comprising:
evaluating a delay associated with transferring Hybrid Automatic Repeat reQuest ACK (HARQ-ACK) feedback received from a User Equipment (UE) for a second cell of the wireless communication network, over a backhaul or sidehaul link of the wireless communication network to a processing entity that is responsible for downlink transmission control in the second cell, wherein the wireless communication network receives the HARQ-ACK feedback in a first cell of the wireless communication network that belongs to a Carrier Aggregation (CA) that is associated with the UE and further includes the second cell; and
selecting, based on the delay evaluation, a particular HARQ-ACK codebook type from among two or more defined HARQ-ACK codebook types, for use by the UE in configuring the HARQ-ACK feedback.

28. The method of claim 27, wherein the first cell is a Primary Cell (PCell) in the CA and the second cell comprises one or more Secondary Cells (SCells) in the CA.

29. The method of claim 28, wherein evaluating the delay comprises evaluating respective delays associated with the one or more SCells.

30. The method of claim 27, further comprising transmitting, or initiating the transmission of signaling indicating the codebook selection to the UE.

31. The method of claim 27, wherein each of the first and second cells is a component carrier having a defined bandwidth and center frequency and providing respective radio resources managed by the wireless communication network.

32. The method of claim 27, wherein the first cell is a Special Cell (SpCell) in the CA and the second cell is a Secondary Cell (SCell) in the CA.

33. The method of claim 27, wherein the evaluating and selecting steps are performed for initial selection of the particular HARQ-ACK codebook type to be used by the UE, in association with connecting the UE with the wireless communication network.

34. The method of claim 27, wherein the evaluating and selecting steps are performed for dynamic reselection of the particular HARQ-ACK codebook type to be used by the UE, in association with the wireless communication network carrying out ongoing communications with the UE.

35. The method of claim 27, wherein the delay comprises a network transport delay and wherein evaluating the delay comprises evaluating a traffic loading or transport-capacity utilization within the wireless communication network bearing on the transfer of the HARQ-ACK feedback to the processing entity that is responsible for downlink transmission control in the second cell.

36. The method of claim 27, wherein evaluating the delay comprises evaluating a first delay metric that is computed as an overall delay between a downlink transmission in the second cell for the UE and receipt by the processing entity of corresponding HARQ-ACK feedback from the UE, as returned by the UE in the first cell and transferred via the backhaul or sidehaul link to the processing entity.

37. The method of claim 27, wherein the two or more defined HARQ-ACK codebook types comprise a dynamic codebook type and a semi-static codebook type.

38. The method of claim 37, wherein the semi-static codebook type is based on structuring the HARQ-ACK feedback with a fixed number of bits and wherein the dynamic codebook type is based on structuring the HARQ-ACK feedback with a variable number of bits.

39. The method of claim 37, wherein evaluating the delay comprises determining whether the delay exceeds a threshold, and wherein selecting the particular HARQ-ACK codebook type comprises selecting the semi-static codebook type responsive to determining that the delay exceeds the threshold.

40. A network node configured for operation in a wireless communication network, the network node comprising:
communication circuitry configured for exchanging signaling with at least one of: other network nodes of the wireless communication network or User Equipments served by the wireless communication network; and
processing circuitry operatively associated with the communication circuitry and configured to:
evaluate a delay associated with transferring Hybrid Automatic Repeat reQuest ACK (HARQ-ACK) feedback received from a UE for a second cell of the wireless communication network, over a backhaul or sidehaul link of the wireless communication network to a processing entity that is responsible for downlink transmission control in the second cell, wherein the wireless communication network receives the HARQ-ACK feedback in a first cell of the wireless communication network that belongs to a Carrier Aggregation (CA) that is associated with the UE and further includes the second cell; and
select, based on the delay evaluation, a particular HARQ-ACK codebook type from among two or more defined HARQ-ACK codebook types, for use by the UE in configuring the HARQ-ACK feedback.

41. The network node of claim 40, wherein the first cell is a Primary Cell (PCell) in the CA and the second cell comprises one or more Secondary Cells (SCells) in the CA.

42. The network node of claim 41, wherein the processing circuitry is configured to evaluate the delay by evaluating respective delays associated with the one or more SCells.

43. The network node of claim 40, wherein the processing circuitry is configured to transmit, or initiate the transmission of, signaling indicating the codebook selection to the UE.

44. The network node of claim 40, wherein each of the first and second cells is a component carrier having a defined bandwidth and center frequency and providing respective radio resources managed by the wireless communication network.

45. The network node of claim 40, wherein the first cell is a Special Cell (SpCell) in the CA and the second cell is a Secondary Cell (SCell) in the CA.

46. The network node of claim 40, wherein the processing circuitry is configured to evaluate the delay and select the particular HARQ-ACK codebook, in association with connecting the UE with the wireless communication network.

47. The network node of claim 40, wherein the processing circuitry is configured to evaluate the delay and select the particular HARQ-ACK codebook on a dynamic basis, in association with the wireless communication network carrying out ongoing communications with the UE.

48. The network node of claim 40, wherein the delay comprises a network transport delay and wherein the processing circuitry is configured to evaluate the delay by evaluating a traffic loading or transport-capacity utilization within the wireless communication network bearing on the transfer of the HARQ-ACK feedback to the processing entity that is responsible for downlink transmission control in the second cell.

49. The network node of claim 40, wherein the processing circuitry is configured to evaluate the delay by evaluating a first delay metric that is computed as an overall delay between a downlink transmission in the second cell for the UE and receipt by the processing entity of corresponding HARQ-ACK feedback from the UE, as returned by the UE in the first cell and transferred via the backhaul or sidehaul link to the processing entity.

50. The network node of claim 40, wherein the two or more defined HARQ-ACK codebook types comprise a dynamic codebook type and a semi-static codebook type.

51. The network node of claim 50, wherein the semi-static codebook type is based on structuring the HARQ-ACK feedback with a fixed number of bits and wherein the dynamic codebook type is based on structuring the HARQ-ACK feedback with a variable number of bits.

52. The network node of claim 50, wherein the processing circuitry is configured to evaluate the delay by determining whether the delay exceeds a threshold and select the particular HARQ-ACK codebook type by selecting the semi-static codebook type responsive to determining that the delay exceeds the threshold.
